(19) United States
(12) Patent Application Publication
(10) Pub. No.: US 2019/0253972 A1
(43) Pub. Date: Aug. 15, 2019

(54) METHOD FOR MANAGING POWER IN WIRELESS LAN SYSTEM AND WIRELESS TERMINAL USING SAME

(71) Applicant: LG ELECTRONICS INC., Seoul (KR)

(72) Inventors: Hyunhee PARK, Seoul (KR); Kiseon RYU, Seoul (KR); Suhwook KIM, Seoul (KR); Jeongki KIM, Seoul (KR); Hangyu CHO, Seoul (KR)

(73) Assignee: LG ELECTRONICS INC., Seoul (KR)

(21) Appl. No.: 16/335,221

(22) PCT Filed: Sep. 20, 2017
(86) PCT No.: PCT/KR2017/010281

§ 371 Date: Mar. 20, 2019

Related U.S. Application Data
(60) Provisional application No. 62/396,848, filed on Sep. 20, 2016.
(60) Provisional application No. 62/431,430, filed on Dec. 8, 2016.
(60) Provisional application No. 62/431,433, filed on Dec. 8, 2016.
(60) Provisional application No. 62/431,833, filed on Dec. 9, 2016.

(51) Int. Cl. H04W 52/02

(52) U.S. Cl. CPC H04W 52/0235; H04W 84/12

(57) ABSTRACT

A method, for managing power, performed by means of a first wireless terminal of the present specification comprises the steps of: transmitting to a second wireless terminal a turn-off packet comprising a power indicator, which indicates that a main radio module enters into a deactivated state, and a TWT request parameter set which is for requesting a TWT operation for a WUR module; if a response packet comprising a TWT response parameter set as a response to the TWT request parameter set is received from the second wireless terminal, indicating the WUR module to maintain a turn-off state until entering a TWT service interval in accordance with the TWT response parameter set; indicating the WUR module to enter into a turn-on state from a turn-off state when entering the TWT service interval; determining whether or not update information is received from the second wireless terminal on the basis of the WUR module in the TWT service interval; and, if the update information is received in the TWT service interval, indicating the main radio module to enter into an activated state.

### BACKGROUND OF THE INVENTION

### Field of the Invention

[1] The present invention relates to wireless communication and, more particularly, to a method for managing power in a wireless LAN system and a wireless terminal using the method.

### Related Art

A next-generation WLAN is aimed at 1) improving Institute of Electrical and Electronics Engineers (IEEE) 802.11 physical (PHY) and medium access control (MAC) layers in bands of 2.4 GHz and 5 GHz, 2) increasing spectrum efficiency and area throughput, and 3) improving performance in actual indoor and outdoor environments, such as an environment in which an interference source exists, a dense heterogeneous network environment, and an environment in which a high user load exists.

In the next-generation WLAN, a dense environment having a great number of access points (APs) and stations (STAs) is primarily considered. Discussions have been conducted on improvement in spectrum efficiency and area throughput in this dense environment. The next-generation WLAN pays attention to actual performance improvement not only in an indoor environment but also in an outdoor environment, which is not significantly considered in the existing WLAN.

Specifically, scenarios for a wireless office, a smart home, a stadium, a hotspot, and the like receive attention in the next-generation WLAN. Discussions are ongoing on improvement in the performance of a WLAN system in the dense environment including a large number of APs and STAs based on relevant scenarios.

Further, in the next generation WLAN, active discussion is expected on system performance improvement in an overlapping basic service set (OBSS) environment, outdoor environmental performance improvement, cellular offloading, or the like, rather than single link performance improvement in one basic service set (BSS). Directionality of the next generation WLAN implies that the next generation WLAN gradually has a technical range similar to mobile communication. Recently, considering that mobile communication and WLAN technologies are discussed together in a small cell and a direct-to-direct (D2D) communication region, technology and business convergence of the next generation WLAN and the mobile communication is expected to be more active.

### SUMMARY OF THE INVENTION

An object of the present specification is to provide a method for managing power to support low-power operations in a wireless LAN system and a wireless terminal using the method.

A method for managing power performed by a first wireless terminal including a main radio module and WUR module according to one embodiment of the present invention comprises transmitting to a second wireless terminal a turn-off packet including a power indicator that instructs that the main radio module enters into a deactivation state and a TWT request parameter set that requests a TWT operation for the WUR module; when an acknowledgement packet including a TWT response parameter set is received from a second wireless terminal in response to the TWT request parameter set, instructing the WUR module to maintain a turn-off state until entering a TWT service period based on the TWT response parameter set; instructing the WUR module to enter into a turn-on state from the turn-off state when entering the TWT service period; determining whether or not update information is received from the second wireless terminal based on the WUR module in the TWT service period; and when the update information is received in the TWT service period, instructing the main radio module to enter into an activation state.

According to one embodiment of the present specification, a method for managing power to support low-power operations in a wireless LAN system and a wireless terminal using the method are provided.

### BRIEF DESCRIPTION OF THE DRAWINGS

FIG. 1 is a conceptual view illustrating the structure of a wireless local area network (WLAN).

FIG. 2 is a diagram illustrating an example of a PPDU used in an IEEE standard.

FIG. 3 is a diagram illustrating an example of an HE PDDU.

FIG. 4 illustrates an internal block diagram of a wireless terminal which receives a wake-up packet.

FIG. 5 illustrates a method for receiving a wake-up packet and a data packet by a wireless terminal.

FIG. 6 illustrates one example of a wake-up packet format.

FIG. 7 illustrates a signal waveform of a wake-up packet.

FIG. 8 illustrates a procedure for determining consumed power according to the ratio of bit values which comprise information in the form of a binary sequence.

FIG. 9 illustrates a process for designing a pulse according to the OOK technique.

FIG. 10 illustrates BSS color information in a multi-BSS environment according to one embodiment of the present invention.

FIG. 11 illustrates channelization of a wireless channel for communication based on the 2.4 GHz band in a wireless LAN system according to one embodiment of the present invention.

FIG. 12 illustrates channelization of a wireless channel for communication based on the 5 GHz band in a wireless LAN system according to one embodiment of the present invention.

FIG. 13 illustrates a WUR target beacon frame for a WUR module according to one embodiment of the present invention.

FIG. 14 illustrates a method for managing power performed by a wireless terminal in a wireless LAN system.

FIG. 15 illustrates a method for managing power in a wireless LAN system according to one embodiment of the present invention.

FIG. 16 illustrates a TWT element for a WUR module according to one embodiment of the present invention.

FIG. 17 is a flow diagram illustrating a method for managing power in a wireless LAN system according to one embodiment of the present invention.

FIG. 18 illustrates a method for managing power in a wireless LAN system according to another embodiment of the present invention.

FIGS. 19 and 20 illustrate a method for managing power in a wireless LAN according to yet another embodiment of the present invention.

FIG. 21 is a block view illustrating a wireless device to which the exemplary embodiment of the present invention can be applied.

### DESCRIPTION OF EXEMPLARY EMBODIMENTS

The aforementioned features and following detailed descriptions are provided for exemplary purposes to facilitate explanation and understanding of the present specification. That is, the present specification is not limited to such an embodiment and thus may be embodied in other forms. The following embodiments are examples only for completely disclosing the present specification and are intended to convey the present specification to those ordinarily skilled in the art to which the present specification pertain. Therefore, where there are several ways to implement constitutional elements of the present specification, it is necessary to clarify that the implementation of the present specification is possible by using a specific method among these methods or any of its equivalents.

When it is mentioned in the present specification that a certain configuration includes particular elements, or when it is mentioned that a certain process includes particular steps, it means that other elements or other steps may be further included. That is, the terminology used herein is for the purpose of describing particular embodiments only, and is not intended to limit the concept of the present specification. Further, embodiments described to help understanding of the invention also includes complementary embodiments thereof.

Terms used in the present specification have the meaning as commonly understood by those ordinarily skilled in the art to which the present specification pertains. Commonly used terms should be interpreted as having a meaning that is consistent with their meaning in the context of the present specification. Further, terms used in the present specification should not be interpreted in an excessively idealized or formal sense unless otherwise defined. Hereinafter, an embodiment of the present specification is described with reference to the accompanying drawings.

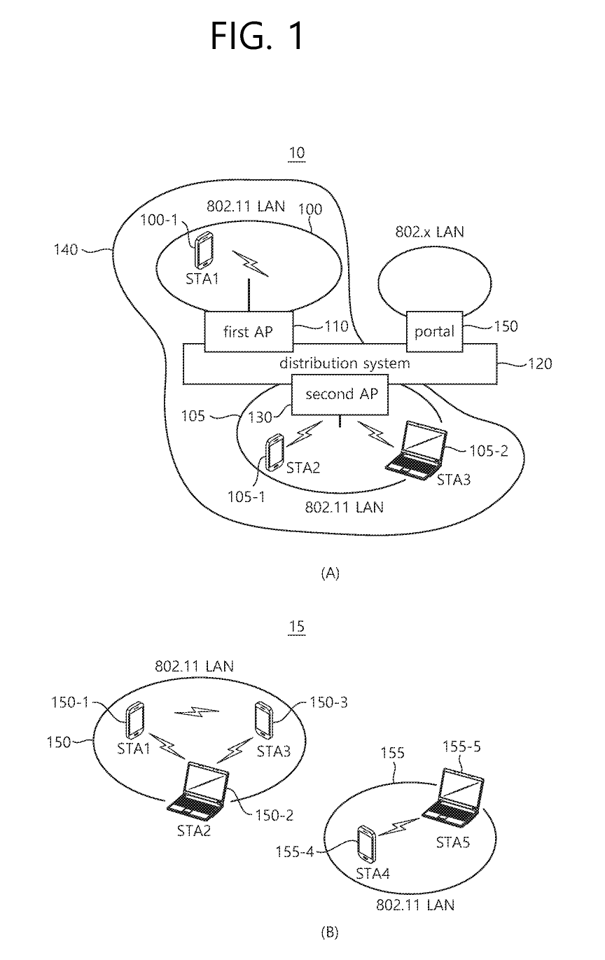

FIG. 1 is a conceptual view illustrating the structure of a wireless local area network (WLAN). FIG. 1 (A) illustrates the structure of an infrastructure basic service set (BSS) of institute of electrical and electronic engineers (IEEE) 802.11.

Referring the FIG. 1 (A), the wireless LAN system (10) of the FIG. 1 (A) may include one or more infrastructure BSSs 100 and 105 (hereinafter, referred to as BSS). The BSSs 100 and 105 as a set of an AP and an STA such as an access point (AP) 125 and a station (STA1) 100-1 which are successfully synchronized to communicate with each other are not concepts indicating a specific region.

For example, The BSS 100 may include one AP 110 and one or more STAs 100-1 which may be associated with one AP 110. The BSS 105 may include one or more STAs 105-1 and 105-2 which may be associated with one AP 130.

The infrastructure BSS 100, 105 may include at least one STA, APs 125, 130 providing a distribution service, and a distribution system (DS) 120 connecting multiple APs.

The distribution system 120 may implement an extended service set (ESS) 140 extended by connecting the multiple BSSs 100 and 105. The ESS 140 may be used as a term indicating one network configured by connecting one or more APs 110 or 130 through the distribution system 120. The AP included in one ESS 140 may have the same service set identification (SSID).

A portal 150 may serve as a bridge which connects the wireless LAN network (IEEE 802.11) and another network (e.g., 802.X).

In the BSS illustrated in the FIG. 1 (A), a network between the APs 110 and 130 and a network between the APs 110 and 130 and the STAs 100-1, 105-1, and 105-2 may be implemented.

FIG. 1 (B) illustrates a conceptual view illustrating the IBSS.

Referring to FIG. 1(B), a WLAN system 15 of FIG. 1(B) may be capable of performing communication by configuring a network between STAs in the absence of the APs 110 and 130 unlike in FIG. 1(A). When communication is performed by configuring the network also between the STAs in the absence of the AP 110 and 130, the network is defined as an ad-hoc network or an independent basic service set (IBSS).

Referring to the FIG. 1 (B), the IBSS is a BSS that operates in an Ad-Hoc mode. Since the IBSS does not include the access point (AP), a centralized management entity that performs a management function at the center does not exist. That is, in the IBSS 15, STAs 150-1, 150-2, 150-3, 155-4, and 155-5 are managed by a distributed manner. In the IBSS, all STAs 150-1, 150-2, 150-3, 155-4, and 155-5 may be constituted as movable STAs and are not permitted to access the DS to constitute a self-contained network.

The STA as a predetermined functional medium that includes a medium access control (MAC) that follows a regulation of an Institute of Electrical and Electronics Engineers (IEEE) 802.11 standard and a physical layer interface for a radio medium may be used as a meaning including all of the APs and the non-AP stations (STAs).

The STA may be called various a name such as a mobile terminal, a wireless device, a wireless transmit/receive unit (WTRU), user equipment (UE), a mobile station (MS), a mobile subscriber unit, or just a user.

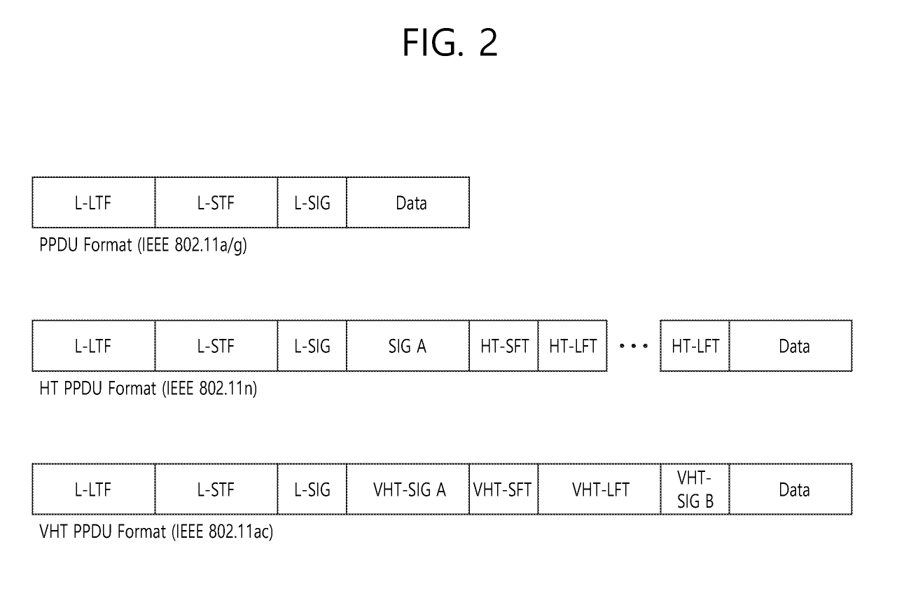

FIG. 2 is a diagram illustrating an example of a PPDU used in an IEEE standard.

As illustrated in FIG. 2, various types of PHY protocol data units (PPDUs) may be used in a standard such as IEEE a/g/n/ac, etc. In detail, LTF and STF fields include a training signal, SIG-A and SIG-B include control information for a receiving station, and a data field includes user data related to a PSDU.

In the embodiment, an improved technique is provided, which is associated with a signal (alternatively, a control information field) used for the data field of the PPDU. The signal provided in the embodiment may be applied onto high efficiency PPDU (HE PPDU) according to an IEEE 802.11ax standard. That is, the signal improved in the embodiment may be HE-SIG-A and/or HE-SIG-B included in the HE PPDU. The HE-SIG-A and the HE-SIG-B may be represented even as the SIG-A and SIG-B, respectively. However, the improved signal proposed in the embodiment is not particularly limited to an HE-SIG-A and/or HE-SIG-B standard and may be applied to control/data fields having various names, which include the control information in a wireless communication system transferring the user data.

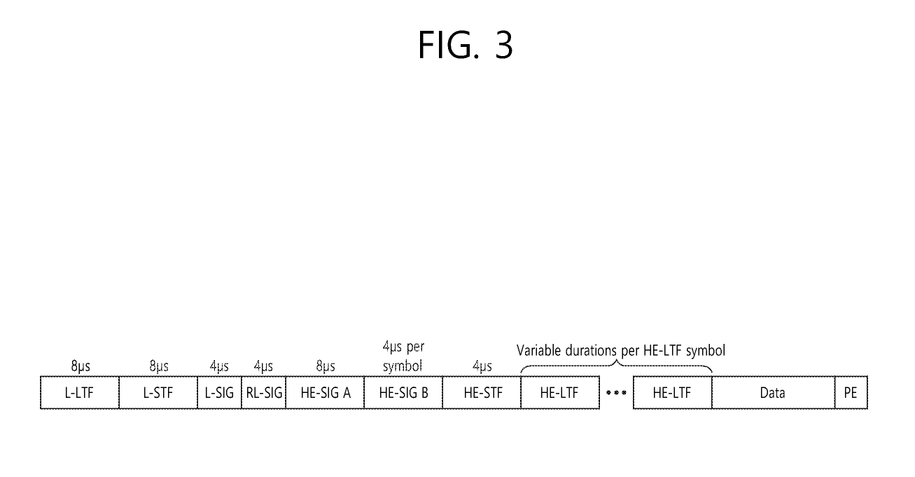

FIG. 3 is a diagram illustrating an example of an HE PDDU.

The control information field provided in the embodiment may be the HE-SIG-B included in the HE PPDU. The HE PPDU according to FIG. 3 is one example of the PPDU for multiple users and only the PPDU for the multiple users may include the HE-SIG-B and the corresponding HE SIG-B may be omitted in a PPDU for a single user.

As illustrated in FIG. 3, the HE-PPDU for multiple users (MUs) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, an MAC payload), and a packet extension (PE) field. The respective fields may be transmitted during an illustrated time period (that is, 4 or 8 μs).

The PPDU used in the IEEE specification is described by a PPDU structure transmitted mainly on the channel bandwidth of 20 MHz. The PPDU structure transmitted on a bandwidth larger than the channel bandwidth of 20 MHz (for example, 40 MHz, 80 MHz) may be a structure which is obtained by applying linear scaling to the PPDU structure used in the channel bandwidth of 20 MHz.

The PPDU structure used in the IEEE specification may be generated based on a 64 Fast Fourier Transform (FFT), where the cyclic prefix (CP) portion occupies a ¼ of the transform. In this case, the length of a valid symbol interval (or FFT interval) may occupies 3.2 μs, CP length 0.8 μs, and symbol duration 4 μs (3.2 μs+0.8 μs) which is obtained by adding the valid symbol interval and the CP length.

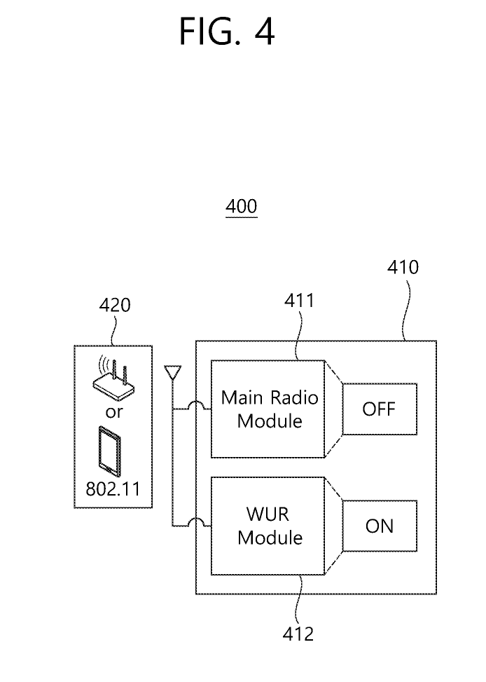

FIG. 4 illustrates an internal block diagram of a wireless terminal which receives a wake-up packet.

Referring to FIG. 4, a wireless LAN system 400 according to the present embodiment may include a first wireless terminal 410 and a second wireless terminal 420.

The first wireless terminal 410 may include a main radio module 411 related to main radio (namely 802.11) and a low-power wake-up receiver (LP WUR) 412 (hereinafter, WUR module). The main radio module 411 may transmit user data or receive user data in an activation state (namely ON state).

In the absence of data (or packet) to be transmitted by the main radio module 411, the first wireless terminal 410 may instruct the main radio module 411 to enter a deactive state (namely OFF state). For example, the main radio module 411 may include a plurality of circuits which support Wi-Fi, Bluetooth radio (hereinafter, BT radio), and Bluetooth low energy radio (hereinafter, BLE radio).

According to conventional methods, a wireless terminal operating based on a power save mode may operate in the activation state or sleep state.

For example, a wireless terminal in the activation state may receive all of the frames from other wireless terminals. Also, a wireless terminal in the sleep state may receive specific type of frames (for example, a beacon frame transmitted periodically) transmitted by other wireless terminal (for example, AP).

A wireless terminal described in the present specification is assumed to operate the main radio module in the activation state or deactivation state.

A wireless terminal including the main radio module 411 in the deactivation state (namely OFF state) may not receive a frame (for example, a PPDU of 802.11 type) transmitted by other wireless terminal (for example, AP) before the main radio module is woken up by the WUR module 412.

As one example, a wireless terminal including the main radio module 411 in the deactivation sate (namely OFF state) is unable to receive even a beacon frame transmitted periodically from an AP.

In other words, a wireless terminal including the main radio module (for example, 411) in the deactivation state (namely OFF state) may be understood to be in a deep sleep state.

Also, a wireless terminal including the main radio module 411 in the activation state (namely ON state) may receive a frame (for example, a PPDU of 802.11 type) transmitted by other wireless terminal (for example, AP).

Also, a wireless terminal described in the present specification is assumed to operate the WUR module in a turn-off or turn-on state.

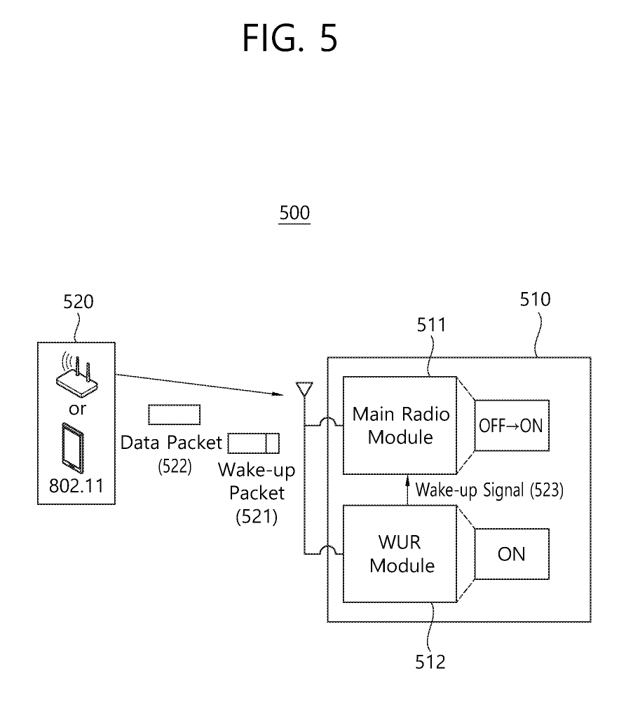

A wireless terminal including the WUR module 412 in the turn-on state may receive only specific type of frames transmitted by other wireless terminal. In this case, the specific type of frames may be regarded as frames modulated by on-off keying (OOK) modulation which is described later with reference to FIG. 5.

A wireless terminal including the WUR module 412 in the turn-off state is unable to receive even the specific type of frames transmitted by other wireless terminal.

In the present specification, to represent the ON state of a particular module included in a wireless terminal, terms for the activation state and turn-on state may be used interchangeably. In the same context, to represent the OFF state of a particular module included in a wireless terminal, terms for the deactivation state and turn-off state may be used interchangeably.

A wireless terminal according to the present embodiment may receive frames (or packets) from other wireless terminal by using the main radio module 411 or WUR module 412.

The WUR module 412 may be a receiver for waking up the main radio module 411. In other words, the WUR module 412 may include a transmitter. The WUR module 412 may maintain the turn-on state while the main radio module 411 is in the deactivation state.

For example, if a wake-up packet (hereinafter, ‘WUP’) for the main radio module 411 is received, the first wireless terminal 410 may instruct the main radio module in the deactivation state to enter into the activation state.

A low power wake-up receiver (LP WUR) included in the WUR module 412 aims to achieve target power consumption of less than 1 mW in the activation state. Also, the LP WUR may use a narrow bandwidth less than 5 MHz.

Also, power consumption due to the LP WUR may be less than 1 mW. Also, the target transmission range of the LP WUR may be the same as the target transmission range of the existing 802.11.

The second wireless terminal according to the present embodiment may transmit user data based on the main radio (namely, 802.11). The second wireless terminal 420 may transmit a WUP for the WUR module 412.

Referring to FIG. 4, the second wireless terminal 420 may not transit user data or WUP for the first wireless terminal 410. In this case, the main radio module 411 may be in the deactivation state (namely OFF state), and the WUR module 412 may be in the turn-on state (namely, ON state).

FIG. 5 illustrates a method for receiving a wake-up packet and a data packet by a wireless terminal.

Referring to FIGS. 4 and 5, a wireless LAN system 500 according to the present embodiment may include a first wireless terminal 510 related to a receiver and a second wireless terminal 520 related to a transmitter. The basic operation of the first wireless terminal 510 of FIG. 5 may be understood through the descriptions given for the first wireless terminal 410 of FIG. 4. In the same manner, the basic operation of the second wireless terminal 520 of FIG. 5 may be understood through the descriptions given for the second wireless terminal 40 of FIG. 4.

Referring to FIG. 5, if a WUR module 512 in the activation state receives a wake-up packet 521, the WUR module 512 may deliver the wake-up signal 523 to the main radio module 511 so that the main radio module 511 may correctly receive a data packet 522 to be received next to the wake-up packet 521.

For example, the wake-up signal 523 may be implemented based on the primitive signal inside the first wireless terminal 510.

As one example, if receiving the wake-up signal 523, all or part of a plurality of circuits (not shown) supporting Wi-Fi, BT radio, and BLE radio included in the main radio module 511 may be activated.

As another example, actual data included in the wake-up packet 521 may be delivered directly to a memory block (not shown) of the receiver even if the main radio module 511 is in the deactivation state.

As yet another example, when the IEEE 802.11 MAC frames are included in the wake-up packet 521, the receiver may activate only the MAC processor of the main radio module 511. In other words, the receiver may maintain the PHY module of the main radio module 511 at the deactivation state. The wake-up packet 521 of FIG. 5 will be described in more detail with reference to the drawings introduced later.

The second wireless terminal 520 may be configured to transmit the wake-up packet 521 to the first wireless terminal 510. For example, the second wireless terminal 520 may instruct the main radio module 511 of the first wireless terminal 510 to enter into the activation state (namely ON state) according to the wake-up packet 521.

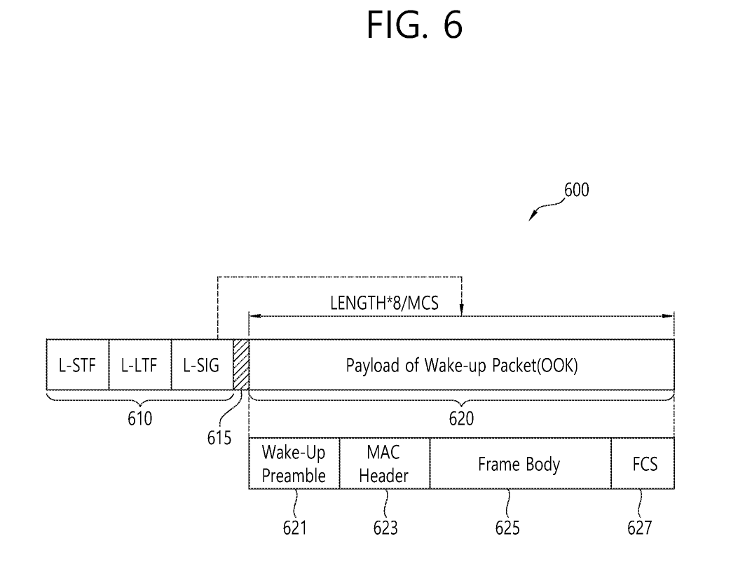

FIG. 6 illustrates one example of a wake-up packet format.

Referring to FIGS. 1 to 6, a wake-up packet 600 may include one or more legacy preambles 610. Also, the wake-up packet 600 may include a payload 620 subsequent to the legacy preamble 610. The payload 620 may be modulated according to a simple modulation scheme (for example, on-off keying (OOK) modulation scheme). The wake-up packet including a payload may be transmitted by employing a relatively small bandwidth.

Referring to FIGS. 1 to 6, the second wireless terminal (for example, 520) may be configured to generate and/or transmit a wake-up packet 521, 600. The first wireless terminal (for example, 510) may be configured to process the received wake-up packet 521.

For example, the wake-up packet 600 may include a legacy preamble 610 defined in the existing IEEE 802.11 standard or arbitrary other preamble (not shown). The wake-up packet 600 may include one packet symbol 615 next to the legacy preamble 610. Also, the wake-up packet 600 may include a payload 620.

The legacy preamble 610 may be provided for the purpose of coexistence with a legacy STA. An L-SIG field for protecting a packet may be used for the legacy preamble 610 for coexistence.

For example, an 802.11 STA may detect the start portion of a packet through the L-STF field within the legacy preamble 610. An STA may detect the end portion of the 802.11 packet through the L-SIG field within the legacy preamble 610.

To reduce a false alarm of an 802.11n terminal, one modulated symbol 615 may be added next to the L-SIG of FIG. 6. One symbol 615 may be modulated according to the BiPhase Shift Keying (BPSK) scheme. One symbol 615 may have a length of 4 μs. One symbol 615 may have a bandwidth of 20 MHz as the legacy part.

The legacy preamble 610 may be understood as a filed for a third party legacy STA (STA not including the LP-WUR). In other words, the legacy preamble 610 may not be decoded by the LP-WUR.

The payload 620 may include a wake-up preamble field 621, MAC header field 623, frame body field 625, and frame check sequence (FCS) field 627.

The wake-up preamble field 621 may include a sequence for identifying the wake-up packet 600. For example, the wake-up preamble field 621 may include a pseudo random noise (PN) sequence.

The MAC header field 624 may include address information (or identifier of a receiver) which indicates a receiver receiving the wake-up packet 600. The frame body field 626 may include other information of the wake-up packet 600.

The frame body 626 may include length or size information of a payload. Referring to FIG. 6, the length information of the payload may be computed based on the length and MCS information included in the legacy preamble 610.

The FCS field 628 may include a cyclic redundancy check (CRC) value for error correction. For example, the FCS field 628 may include the MAC header field 623 and CRC-8 or CRC-16 value for the frame body 625.

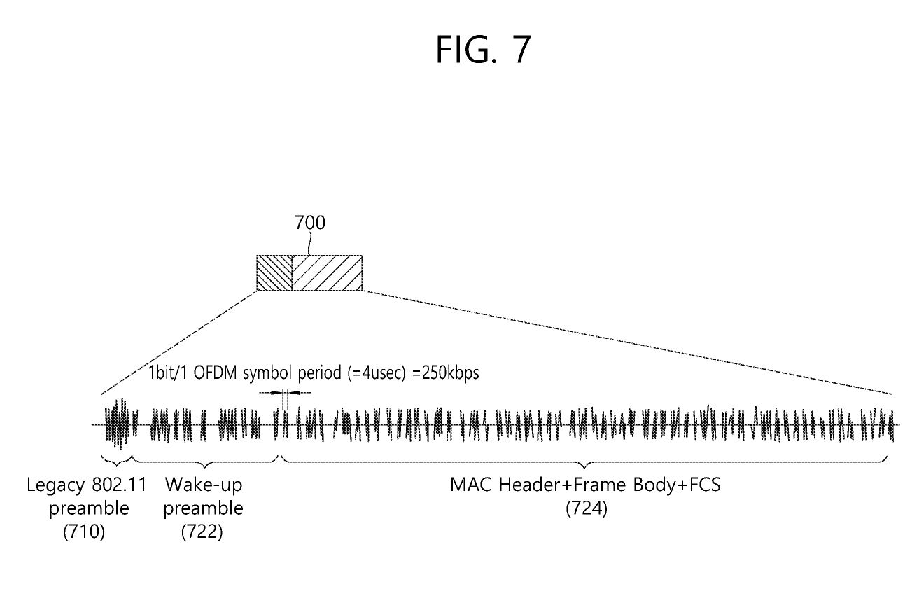

FIG. 7 illustrates a signal waveform of a wake-up packet.

Referring to FIG. 7, a wake-up packet 700 may include a legacy preamble (802.11 preamble) 710 and a payload 722, 724 modulated based on the on-off keying (OOK). In other words, the wake-up packet (WUP) according to the present embodiment may be understood as a form in which the legacy preamble and a new LP-WUR signal waveform coexist.

The OOK scheme may not be applied to the legacy preamble of FIG. 7. As described above, the payload 722, 724 may be modulated by the OOK scheme. However, the wake-up preamble 722 included in the payload 722, 724 may be modulated according to a different modulation scheme.

As one example, suppose the legacy preamble 710 is transmitted based on a channel bandwidth of 20 MHz to which a 64-point FFT is applied. In this case, the payload 722, 724 may be transmitted based on a channel bandwidth of about 4.06 MHz.

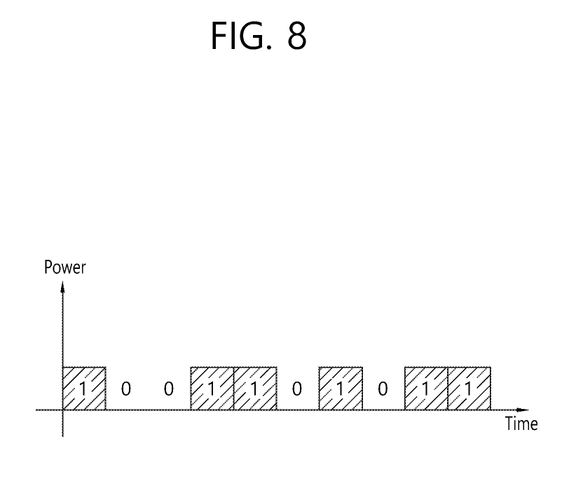

FIG. 8 illustrates a procedure for determining consumed power according to the ratio of bit values which comprise information in the form of a binary sequence.

Referring to FIG. 8, information may be expressed in the form of a binary sequence consisting of ‘0’s and ‘1’s. Communication based on the OOK modulation scheme may be performed according to the bit values contained in the information of a binary sequence.

For example, when light emitting diodes are used for visible light communication, if the bit value constituting the information in the form of a binary sequence is ‘1’, the light emitting diode is turned on while the light emitting diode is turned off if the bit value is ‘0’.

A receiver receives data transmitted through a visible light as the light emitting diode is turned on or off and reconstructs the data, and thereby visible light communication is enabled. However, since the human eye is unable to recognize the on-off switching of a light emitting diode, a human feels that the light is kept to be turned on.

For the convenience of descriptions, as shown in FIG. 8, information in the form of a binary sequence comprising 10 bits may be provided. For example, information in the form of a binary sequence having a value of ‘1001101011’.

As described above, if a transmitter is turned on when the bit value is ‘1’ and turned off, when the bit value is ‘0’, symbols related to the 6 bits among the 10 bits are turned on.

The wake-up receiver (WUR) according to the present embodiment is included in a receiver, transmission power of a transmitter may not be taken into account significantly. The reason why the OOK scheme is used in the present embodiment is that the power consumed during a demodulation procedure of a received signal is considerably small.

There may not be a considerable difference between the power consumed by the main radio and the power consumed by the WUR until the demodulation procedure is performed. However, as the demodulation procedure is performed by the receiver, a significant difference may be developed between the power consumed in the main radio module and the power consumed in the WUR module. The following provides an approximate estimation of consumed power.
Existing Wi-Fi power consumption is about 100 mW. More specifically, power consumption may be caused as follows: resonator+oscillator+PLL (1500 uW)→LPF (300 uW)→ADC (63 uW)→decoding processing (OFDM receiver) (100 mW).
However, WUR power consumption is about 1 mW. More specifically, power consumption may be caused as follows: resonator+oscillator (600uW)→LPF (300 uW)→ADC (20 uW)→decoding processing (envelope detector) (1 uW)

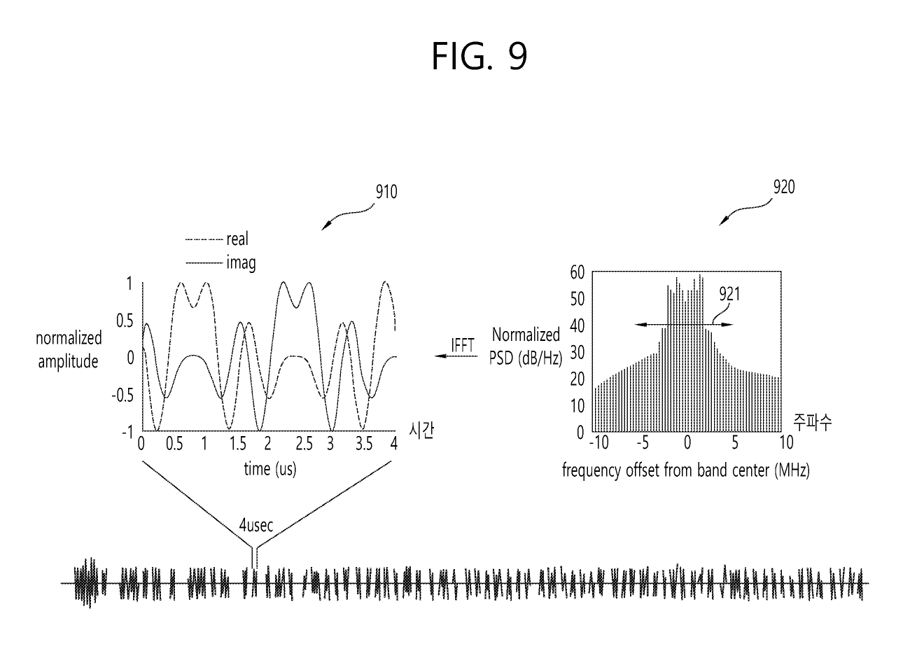

FIG. 9 illustrates a process for designing a pulse according to the OOK technique.

A wireless terminal according to the present embodiment may use an OFDM transmitter of the legacy 802.11 to generate pulses according to the OOK scheme. The OFDM transmitter of the legacy 802.11 may generate a sequence having 64 bits by applying a 64-point IFFT.

Referring to FIGS. 1 to 9, a wireless terminal according to the present embodiment may transmit a payload of a wake-up packet modulated according to the OOK scheme. The payload (for example, 620 of FIG. 6) according to the present embodiment may be implemented based on the ON signal and OFF signal.

The OOK scheme may be applied to the ON signal included in the payload (for example, 620 of FIG. 6) of the wake-up packet (WUP). In this case, the ON signal may be a signal containing an actual power value.

Referring to the graph 920 in the frequency domain, a signal included in the payload (for example, 620 of FIG. 6) may be obtained by performing IFFT to N2 (where N2 is a natural number) subcarriers among N1 (where N1 is a natural number) subcarriers related to the channel band of the WUP. Also, a preconfigured sequence may be applied to the N2 subcarriers.

For example, the channel bandwidth of the WUP may be 20 MHz. N1 subcarriers may be 64 subcarriers, and N2 subcarriers may be 13 consecutive subcarriers (921 of FIG. 9). The subcarrier spacing used for the WUP may be 312.5 kHz.

The OOK scheme may be applied for the OFF-signal included in the payload (for example, 620 of FIG. 6) of the WUP. The OFF signal may be a signal which does not have an actual power value. In other words, the OFF signal may not be considered in the composition of the WUP.

The ON signal included in the payload (620 of FIG. 6) of the WUP may be determined (namely demodulated) as a 1-bit ON signal (namely ‘1’) by the WUR module (for example, 512 of FIG. 5). In the same way, the OFF signal included in the payload may be determined (namely demodulated) as a 1-bit OFF signal by the WUR module (for example, 512 of FIG. 5).

A specific sequence may be preconfigured for the subcarrier set 921 of FIG. 9. In this case, the preconfigured sequence may be a 13-bit sequence. As one example, the coefficient related to a DC subcarrier among the 13-bit sequence may be set to ‘0’ while the remaining coefficients may be set to ‘1’ or ‘-1’.

Referring to the graph 920 in the frequency domain, the subcarrier set 921 may correspond to the subcarriers the subcarrier indexes of which range from ‘-6’ to ‘+6’.

For example, the coefficients related to the subcarriers the subcarrier indexes of which range from ‘−6’ to ‘−1’ may be set to ‘1’ or ‘−1’. The coefficients among the 13-bit sequence, related to the subcarriers the subcarrier indexes of which correspond range from ‘1’ to ‘6’, may be set to ‘1’ or ‘−1’.

For example, the subcarriers among the 13-bit sequence, the subcarrier indexes of which are ‘0’, maybe nulled. The coefficients of the remaining subcarriers (subcarrier indexes of which range from ‘−32’ to ‘−7’ and from ‘+7’ to ‘+31’) except for the subcarrier set 921 may all be set to ‘0’.

The subcarrier set 921 related to 13 consecutive subcarriers may be configured to have a channel bandwidth of about 4.06 MHz. In other words, signal power may be concentrated on the band of 4.06 MHz among the band of 20 MHz for the WUP.

If pulses generated by the OOK scheme according to the present embodiment, an advantage is obtained that signal to noise ratio (SNR) may be increased as power is concentrated on a specific band, and consumption of power for conversion in the AC/DC converter of a receiver may be reduced. Since the sampling frequency band is reduced to 4.06 MHz, power consumption due to a wireless terminal may be reduced.

Another OFDM transmitter of the 802.11 according to the present embodiment may perform IFFT (for example, 64-point IFFT) on N2 (for example, 13 consecutive) subcarriers among N1 (for example, 64) subcarriers related to the channel bandwidth (for example, a band of 20 MHz) of the wake-up packet.

In this case, a preconfigured sequence may be applied to the N2 subcarriers. Accordingly, one ON signal may be generated in the time domain. 1-bit information related to the one ON signal may be delivered through one symbol.

For example, when the 64-point IFFT is performed, a symbol having a length of 3.2 μs related to the subcarrier set 921 may be generated. Also, if a cyclic prefix (CP, 0.8 μs) is added to the symbol having a length of 3.2 μs which corresponds to the subcarrier set 921, one symbol having a total length of 4 μs may be generated as shown in the time domain graph 910 of FIG. 9.

Also, the OFDM transmitter of the 802.11 may not transmit an OFF signal at all.

According to the present embodiment, a first wireless terminal (for example, 510 of FIG. 5) including the WUR module (for example, 512 of FIG. 5) may demodulate a received packet based on an envelope detector extracting the envelope of a received signal.

For example, the WUR module (for example, 512 of FIG. 5) according to the present embodiment may compare the power level of a received signal obtained through the envelope of the received signal with a preconfigured threshold level.

If the power level of a received signal is higher than the threshold level, the WUR module (for example, 512 of FIG. 5) may determine the received signal as a 1-bit ON signal (namely, ‘1’). If the power level of the received signal is lower than the threshold level, the WUR module (for example, 512 of FIG. 5) may determine the received signal as a 1-bit OFF signal (namely, ‘0’).

According to the present one embodiment, a basic data rate for one information may be 125 Kbps (8 μs) or 62.5 Kbps (16 μs).

To generalize the description of FIG. 9, each signal whose length in the band of 20 MHz is K (for example, K is a natural number) may be transmitted based on K consecutive subcarriers among 64 subcarriers for the band of 20 MHz. For example, K may correspond to the number of subcarriers used for transmitting a signal. Also, K may correspond to the bandwidth of a pulse according to the OOK scheme.

The coefficients of the remaining subcarriers except for the K subcarriers among 64 subcarriers may all be set to ‘0’.

More specifically, K identical subcarriers may be used for both a 1-bit OFF signal (hereinafter, information 0) related to ‘0’ and a 1-bit ON signal (hereinafter, information 1) related to ‘1’. For example, the index for the K subcarriers used may be expressed by 33-floor(K/2): 33+ceil(K/2)−1.

At this time, information 1 and 0 may have the following values.
Information 0=zeros(1, K)
Information 1=alpha*ones(1, K)

The alpha is a power normalization factor and may be 1/sqrt(K), for example.

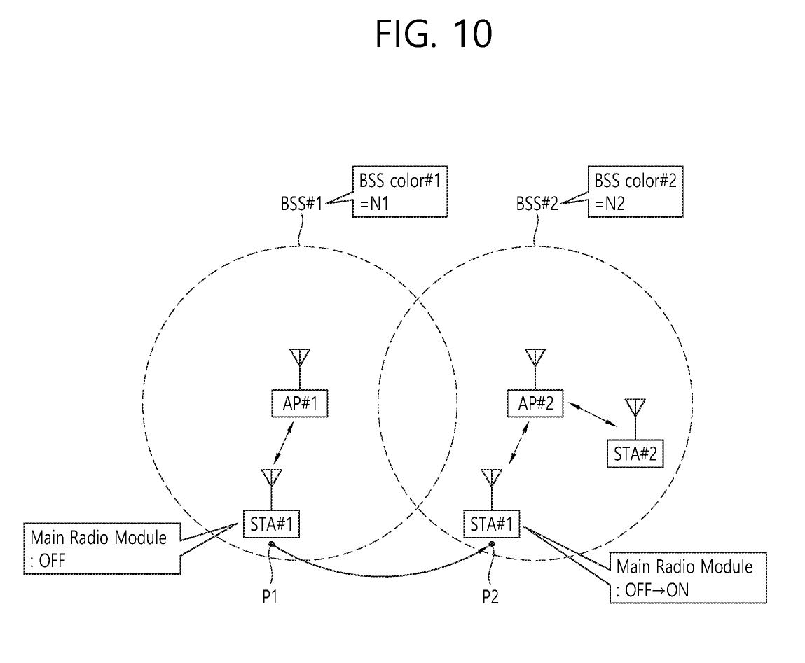

FIG. 10 illustrates BSS color information in a multi-BSS environment according to one embodiment of the present invention.

Referring to FIG. 10, two circles drawn by dotted lines represent individual BSSs (BSS#1, BSS#2). For a clear and simple description of FIG. 10, a first BSS (BSS#1) and second BSS (BSS#2) may be regarded as an infrastructure BSS which is a kind of infrastructure network.

For example, the first BSS (BSS#1) may include a first AP (AP#1) and a first STA (STA#1) combined with the first AP (AP#1). The second BSS (BSS#2) may include a second AP (AP#2) and a second STA (STA#2) combined with the second AP (AP#2).

In other words, the first AP (AP#1) may be regarded as an entity which provides access to a distributed system (DS) for the first STA (STA#1) through a wireless medium. In the same manner, the second AP (AP#2) may be regarded as an entity which provides access to the DS for the second STA (STA#2) through the wireless medium.

Also, the first STA (STA#1) and second STA (STA#2) may be regarded as a terminal which includes the main radio module (namely 511 of FIG. 5) and WUR module (namely 512 of FIG. 5) like the first wireless terminal (namely 510 of FIG. 5) described in FIG. 5 above.

The degree of influence due to other neighboring BSS may differ depending on a relative position of each wireless terminal (for example, AP or STA) of FIG. 10. In other words, each wireless terminal (for example, AP or STA) may detect communication environment information.

For example, communication environment information may be local information detected by a wireless terminal. As one example, the local information may be regarded as a numeric value (or information) varied according to the change of the relative position of a wireless terminal with respect to other wireless terminal.

The communication environment information according to the present embodiment may include Basic Service Set (BSS) color information. BSS color information may be 6-bit information configured by each AP (AP#1, AP#2) belonging to each BSS (BSS#1, BSS#2). The BSS color information (hereinafter, ‘BCI’) may be set to any one of ‘0’ to ‘63’.

More specifically, the BSS color information may be an identifier of the BSS (for example, BSS#1, BSS#2). The BSS color information (BCI) may be used to help a receiver identify a BSS.

In the description give below, an HE STA which transmits an HE operation element or BSS color change announcement element may be regarded as not being a non-AP STA combined with an HE AP.

The HE STA which transmits an HE operation element or BSS color change announcement element may select a BSS color value to be included into the BSS color subfield of the HE operation element or new BSS color subfield of the BSS color change announcement element.

For example, the BSS color value may be set to any one of ‘0’ to ‘63’. The HE STA may maintain a single value of the BSS color field during the lifetime of the BSS (or until the BSS color information is changed).

The HE STA which has transmitted the HE operation element may be set BSS_COLOR, which is a TXVECTOR parameter of an HE PPDU, to a value indicated by the BSS color subfield of the HE operation element.

The BSS color information (BCI) according to the present embodiment may be included in the HE PPDU as shown in FIG. 3. More specifically, the BSS color information may be included in the HE-SIG A field of the HE PPDU.

For example, the first BSS color information (BCI_1) for the first BSS (BSS#1) may be set to N1 (where N1 is a natural number). The second BSS color information (BCI_2) for the second BSS (BSS#2) may be set to N2 (where N1 is a natural number).

According to the present one embodiment, the first AP (AP#1) may transmit a frame which includes the first BSS color information (BCI_1). The second AP (AP#2) may transmit a frame which include the second BSS color information (BCI_2).

According to the present one embodiment, the first STA (STA#1) may receive only the frame which includes the first BSS color information (BCI_1). In other words, the first STA (STA#1) may ignore the frame which include the second BSS color information (BCI_2) from the second AP (AP#2) of the second BSS (BSS#2).

More specifically, the first STA (STA#1) may receive the remaining portion (namely the portion following the HE-SIG A field of the HE PPDU only when the BSS color information obtained through the HE-SIG A field of the HE PPDU of a received frame matches the BSS color information (namely BCI1) of a BSS (namely BSS#1) to which the first STA (STA#1) belongs.

In the same manner, the second STA (STA#2) may receive only the frame which include the second BSS color information (BCI_2). In other words, the second STA (STA#2) may ignore the frame which includes the first BSS color information (BCI_1) from the first AP (AP#1) of the first BSS (BSS#1).

More specifically, the second STA (STA#2) may receive the remaining portion (namely the portion following the HE-SIG A field) of the HE PPDU only when the BSS color information obtained through the HE-SIG A field of the HE PPDU of a received frame matches the BSS color information (namely BCI2) of a BSS (namely BSS#2) to which the second STA (STA#2) belongs.

As the BSS color information described above is introduced to a wireless LAN system according to the present embodiment, performance of the wireless LAN system in the OBSS environment may be improved. A procedure for turning on a main radio module according to a movement of the first STA (STA#1) shown in FIG. 10 will be described in more detail through the appended drawings shown later.

Also, a more detailed description of the BSS color information may be more clearly understood by referring to Clauses 27.11.4 and 27.16.2 of the IEEE P802.11ax/D1.3, a standard disclosed at June, 2017.

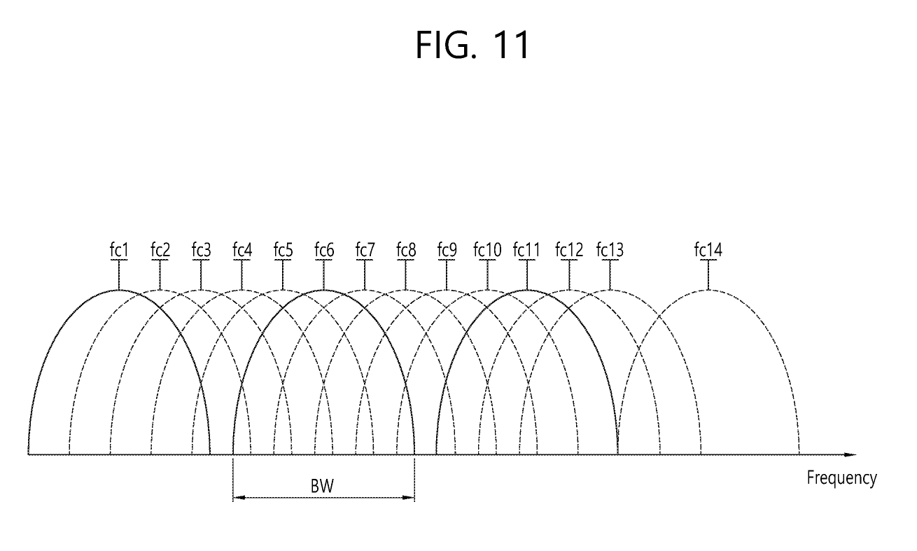

FIG. 11 illustrates channelization of a wireless channel for communication based on the 2.4 GHz band in a wireless LAN system according to one embodiment of the present invention.

Referring to FIG. 11, the horizontal axis of FIG. 11 may represent the frequency component in the 2.4 GHz band. The vertical axis of FIG. 11 may be associated with existence of a channel.

To support the operation of a wireless terminal according to one embodiment of the present invention in the 2.5 GHz band of FIG. 11, first to thirteen channels (ch#1 ˜ch#13) may be allocated. For example, bandwidth for each of the first to the thirteen channel (ch#1 ˜ch#13) may be 22 MHz.

The first channel center frequency (fc1) for the first channel (ch#1) of FIG. 11 may be 2.412 GHz. For example, the first channel (ch#1) may be defined between 2.401 GHz and 2.423 GHz. Also, the second channel center frequency (fc2) for the second channel (ch#2) may be 2.417 GHz. For example, the second channel (ch#2) may be defined between 2.406 GHz and 2.428 GHz.

The third channel center frequency (fc3) for the third channel (ch#3) of FIG. 11 may be 2.422 GHz. For example, the third channel (ch#3) may be defined between 2.411 GHz and 2.433 GHz. Also, the fourth channel center frequency (fc4) for the fourth channel (ch#4) may be 2.427 GHz. For example, the fourth channel (ch#4) may be defined between 2.416 GHz and 2.438 GHz.

The fifth channel center frequency (fc5) for the fifth channel (ch#5) of FIG. 11 may be 2.432 GHz. For example, the fifth channel (ch#5) may be defined between 2.421 GHz and 2.443 GHz. Also, the sixth channel center frequency (fc6) for the sixth channel (ch#6) may be 2.437 GHz. For example, the sixth channel (ch#6) may be defined between 2.426 GHz and 2.448 GHz.

The seventh channel center frequency (fc7) for the seventh channel (ch#7) of FIG. 11 may be 2.442 GHz. For example, the seventh channel (ch#7) may be defined between 2.431 GHz and 2.453 GHz. Also, the eighth channel center frequency (fc8) for the eighth channel (ch#8) may be 2.447 GHz. For example, the eighth channel (ch#8) may be defined between 2.436 GHz and 2.458 GHz.

The ninth channel center frequency (fc9) for the ninth channel (ch#9) of FIG. 11 may be 2.452 GHz. For example, the ninth channel (ch#9) may be defined between 2.441 GHz and 2.463 GHz. Also, the tenth channel center frequency (fc10) for the tenth channel (ch#10) may be 2.457 GHz. For example, the tenth channel (ch#10) may be defined between 2.446 GHz and 2.468 GHz.

The eleventh channel center frequency (fc11) for the eleventh channel (ch#11) of FIG. 11 may be 2.462 GHz. For example, the eleventh channel (ch#11) may be defined between 2.451 GHz and 2.473 GHz. Also, the twelfth channel center frequency (fc12) for the twelfth channel (ch#12) may be 2.467 GHz. For example, the twelfth channel (ch#12) may be defined between 2.456 GHz and 2.478 GHz.

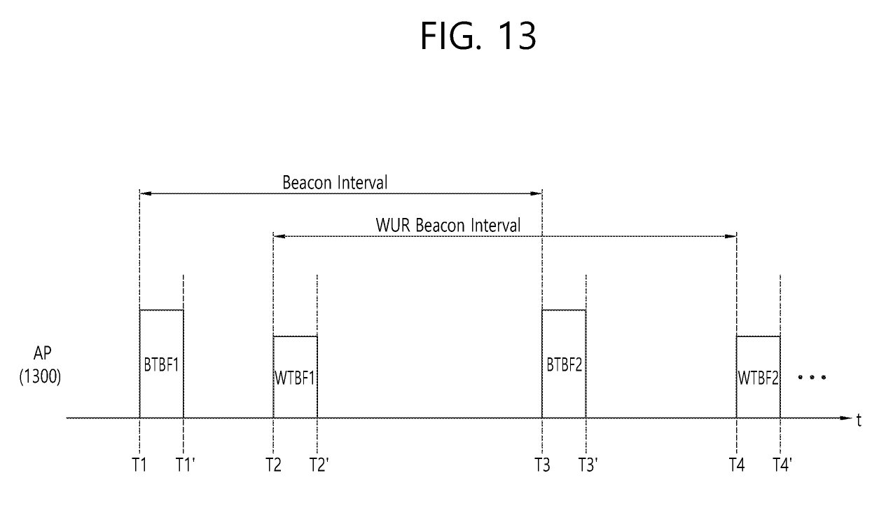

The thirteenth channel center frequency (fc13) for the thirteenth channel (ch#13) of FIG. 13 may be 2.472 GHz. For example, the thirteenth channel (ch#13) may be defined between 2.461 GHz and 2.483 GHz. Also, the fourteenth channel center frequency (fc14) for the fourteenth channel (ch#14) may be 2.482 GHz. For example, the fourteenth channel (ch#14) may be defined between 2.473 GHz and 2.495 GHz.

It should be noted that the twelfth channel (ch#12) and the thirteenth channel (ch#13) may be used in most countries except for the United States. The fourteenth channel (ch#14) is used only in Japan.

Referring to FIG. 11, the first (ch#1), sixth (ch#6), and eleventh channel (ch#11) drawn by solid lines may be regarded as independent channels not overlapping each other in the frequency domain. The channelization of wireless channels for communication based on the 2.4 GHz band shown in FIG. 11 is only an example, and it should be noted that the present specification is not limited to the specific example.

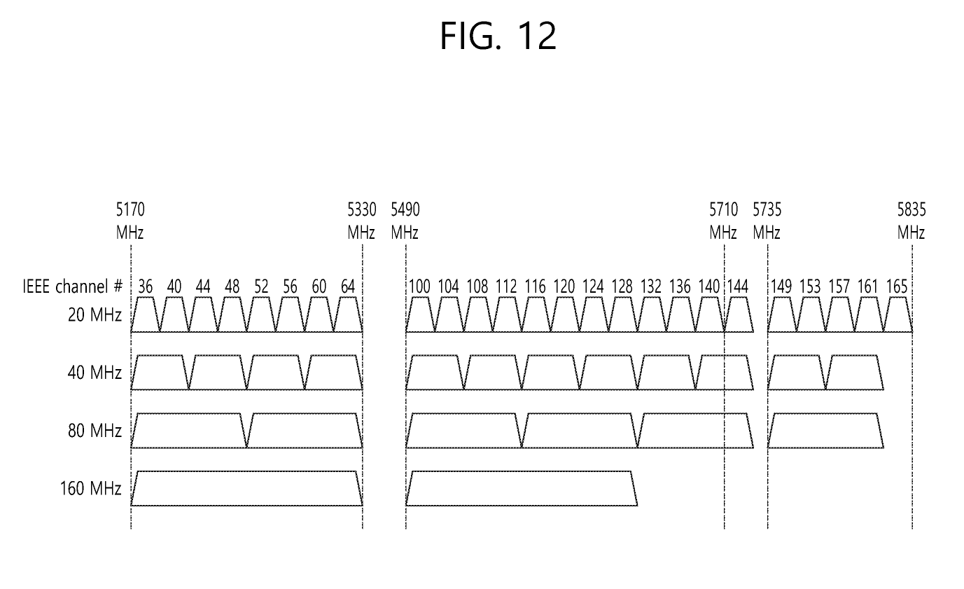

FIG. 12 illustrates channelization of a wireless channel for communication based on the 5 GHz band in a wireless LAN system according to one embodiment of the present invention. To support the operation of a wireless terminal in the 5 GHz band according to the present one embodiment, a plurality of channels having bandwidths of 20 MHz, 40 MHz, 80 MHz, and 160 MHz are employed.

Referring to FIG. 12, the number of non-overlapping channels each of which having a bandwidth of 20 MHz in the 5 GHz band may be 25. For example, the non-overlapping channels may include the 36-th channel (ch#36) having a center frequency of 5.180 GHz, the 40-th channel (ch#40) having a center frequency of 5.200 GHz, the 44-th channel (ch#44) having a center frequency of 5.220 GHz, and the 48-th channel (ch#48) having a center frequency of 5.240 GHz.

Also, the non-overlapping channels may include the 52-th channel (ch#52) having a center frequency of 5.260 GHz, the 56-th channel (ch#56) having a center frequency of 5.280 GHz, the 60-th channel (ch#60) having a center frequency of 5.300 GHz, and the 64-th channel (ch#64) having a center frequency of 5.320 GHz.

Also, the non-overlapping channels may include the 100-th channel (ch#100) having a center frequency of 5.500 GHz, the 104-th channel (ch#104) having a center frequency of 5.520 GHz, the 108-th channel (ch#108) having a center frequency of 5.540 GHz, the 112-th channel (ch#112) having a center frequency of 5.560 GHz, the 116-th channel (ch#116) having a center frequency of 5.580 GHz, the 120-th channel (ch#120) having a center frequency of 5.600 GHz, and the 124-th channel (ch#124) having a center frequency of 5.620 GHz.

Also, the non-overlapping channels may include the 128-th channel (ch#128) having a center frequency of 5.640 GHz, the 132-th channel (ch#132) having a center frequency of 5.660 GHz, the 136-th channel (ch#136) having a center frequency of 5.680 GHz, the 140-th channel (ch#140) having a center frequency of 5.700 GHz, and the 144-th channel (ch#144) having a center frequency of 5.720 GHz.

Also, the non-overlapping channels may include the 149-th channel (ch#149) having a center frequency of 5.745 GHz, the 153-th channel (ch#153) having a center frequency of 5.765 GHz, the 157-th channel (ch#157) having a center frequency of 5.785 GHz, the 161-th channel (ch#161) having a center frequency of 5.805 GHz, and the 165-th channel (ch#165) having a center frequency of 5.825 GHz.

Referring to FIG. 12, the number of non-overlapping channels having a bandwidth of 40 MHz based on channel bonding in the 5 GHz band may be 12. Also, the number of non-overlapping channels having a bandwidth of 80 MHz based on channel bonding in the 5 GHz band may be 6. Also, the number of non-overlapping channels having a bandwidth of 160 MHz based on channel bonding in the 5 GHz band may be 2.

The channelization of wireless channels for communication based on the 5 GHz band shown in FIG. 12 is only one example, and it should be noted that the present specification is not limited to the specific example.

FIG. 13 illustrates a WUR target beacon frame for a WUR module according to one embodiment of the present invention. Referring to FIG. 13, the horizontal axis of FIG. 13 may represent time (t), and the vertical axis of FIG. 13 may be associated with existence of a frame.

Referring to FIGS. 1 to 13, the AP 1300 of FIG. 13 may be regarded as the second wireless terminal (for example, 420, 520) of FIGS. 4 and 5 above. Also, the AP 1300 of FIG. 13 may be regarded as the first AP (AP#1) and second AP (AP#2) of FIG. 10 above.

In the first interval (T1˜T1′) of FIG. 13, the AP 1300 may transmit a first main target beacon frame (hereinafter, ‘MTBF1’). The first MTBF1 may include various control information for associating the AP with an STA.

The MTBF according to the present one embodiment is a kind of management frame, which may be regarded as related to a beacon frame of Clause 9.3.3.3 of the IEEE Draft P802.11-REVmc™/D8.0 disclosed at August 2016.

The MTBF may be transmitted by the AP 1300 according to a beacon interval (hereinafter, ‘BI’) having a predetermined time period. As one example, the beacon interval (BI) (T1˜T3) may be 100 ms.

In the second interval (T2˜T2′) of FIG. 13, the AP 1300 may transmit a first WUR target beacon frame (hereinafter, ‘WTBF1’) for the WUR module (for example, 412, 512) of FIGS. 4 and 5 above.

The WTBF according to the present one embodiment may be transmitted by the AP 1300 according to a WUR beacon interval (hereinafter, ‘WUR BI’) having a predetermined time period.

The WTBF according to the present embodiment may include a plurality of information elements as shown in Table 1 below.

TABLE 1

| Order | Information | Notes |
|---|---|---|
| 1 | Timestamp | Timestamp element represents the value of the |
| | | timing synchronization function (TSF) timer of |
| | | a frame's source. The length of the Timestamp |
| | | field is 8 octets. |
| 2 | Beacon | Beacon interval element represents the period of |
| | interval | WUR target beacon frame. |
| 3 | BSS Color | The BSS Color Change Announcement element is |
| | Change | optionally present when |
| | Announcement | dot11WUROptionImplemented is true; otherwise |
| | | it is not present. |
| 4 | EDCA | The EDCA element is optionally present when |
| | Parameter | dot11WUROptionImlemented is true; otherwise |
| | Set | it is not present. |
| 5 | WUR | The WUR Capabilities element is present when |
| | Capabilities | dot11WUROptionImplemented is true; otherwise |
| | | it is not present. |
| 6 | WUR | The WUR Operation element is present when |
| | Operation | dot11WUROptionImplemented is true; otherwise |
| | | it is not present. |
| 7 | Vender | One or more vendor-specific elements are |
| | Specific | optionally present. These elements follow all |
| | | other elements. |

As one example, the WUR target beacon frame (WTBF) may be transmitted at a shorter period than the main target beacon frame (MTBF). In this case, a wireless terminal may maintain an association with the AP by receiving the WTBF transmitted at a short period instead of receiving the MTBF.

As another one example, the WTBF may be transmitted at a longer period than the MTBF. In this case, a wireless terminal may maintain an association with the AP by receiving the WTBF transmitted at a long period instead of receiving the MTBF.

As yet another one example, the WTBF may be transmitted at the same period of the MTBF. In this case, the WTBF may be defined as an information element and included in the MTBF. Similarly, the WTBF may be transmitted at a different time point from the MTBF but at the same period of the MTBF.

In the third interval (T3˜T3′) of FIG. 13, the AP 1300 may transmit a second main target beacon frame (MTBF2) according to a beacon interval (BI).

In the fourth interval (T4˜T4′) of FIG. 13, the AP 1300 may transmit a second WUR target beacon frame (WTBF2) according to a WUR beacon interval (WUR BI).

Although the WUR target beacon frame (WTBF) of FIG. 13 is transmitted periodically by the AP 1300, this operation is only an example, and it should be understood that the WTBF may be transmitted as an event like the wake-up packet (WUP) shown in FIG. 5.

Referring to FIGS. 5, 10, and 13, a first wireless terminal (namely 510 of FIG. 5 and STA#1 of FIG. 10) including the WUR module (for example, 412, 512) may instruct the 802.11 based main radio module (namely 511 of FIG. 5) to maintain the deactivation state (namely OFF state) for reduction of standby power.

The first wireless terminal (namely 510 of FIG. 5) the main radio module of which is in the deactivation state (namely OFF state) may not receive the main target beacon frame (MTBF) transmitted by the second wireless terminal (namely AP#1 of FIG. 10) belonging to an existing BSS (namely BSS#1 of FIG. 10). Accordingly, a wireless terminal the main radio module of which is in the deactivation state (namely OFF state) may not maintain an association with the AP.

According to the present one embodiment, the AP 1300 may include various control information for maintaining a connection between the AP and wireless terminal in the WUR target beacon frame (WTBF) for the WUR module (for example, 412, 512).

According to the present one embodiment, control information may include the BSS color information (BCI) described with reference to FIG. 10.

Referring to FIGS. 5, 10, and 13, it may be assumed that the first wireless terminal (namely 510 of FIG. 5 and STA#1 of FIG. 10) pre-stores a value (namely N1 of FIG. 10) related to the BSS color information (namely BSS color#1 of FIG. 10) of an existing BSS (namely BSS#1 of FIG. 10).

The first wireless terminal (namely 510 of FIG. 5 and STA#1 of FIG. 10) including the main radio module (namely 511 of FIG. 5) in the deactivation state (namely OFF state) may move to a second location (namely P2 of FIG. 10) belonging to a different BSS (namely BSS#2 of FIG. 10) from a first location (namely P1 of FIG. 10) belonging to the existing BSS (namely BSS#1 of FIG. 10).

In this case, the WUR target beacon frame (WTBF) transmitted from a different, second wireless terminal (namely AP#2 of FIG. 10) belonging to the different BSS (namely BSS#2 of FIG. 10) may include a value (namely N2 of FIG. 10) related to other BSS color information (namely BSS color#2 of FIG. 10).

A WUR target beacon frame (WTBF) including BSS color information different from the existing one (namely BSS color#2 of FIG. 10) may be received based on the WUR module (namely 512 of FIG. 5) of the first wireless terminal (namely 510 of FIG. 5 and STA#1 of FIG. 10). In this case, the first wireless terminal (namely 510 of FIG. 5 and STA#1 of FIG. 10) may instruct the main radio module (511 of FIG. 5) to enter into the activation state (namely ON state) from the deactivation state (namely OFF state).

Next, the first wireless terminal (namely 510 of FIG. 5 and STA#1 of FIG. 10) according to the present one embodiment may receive a main target beacon frame (MTBF) transmitted from the different, second wireless terminal (namely AP#2 of FIG. 10) belonging to the different BSS (namely BSS#2 of FIG. 10) based on the main radio module (namely 510 of FIG. 5) in the activation state (namely ON state).

Next, the wireless terminal according to the present one embodiment (namely 510 of FIG. 5 and STA#1 of FIG. 10) may perform an association procedure with the second wireless terminal (namely AP#2 of FIG. 10).

According to the present one embodiment, control information may include channel information due to channelization described with reference to FIGS. 11 and 12.

Referring to FIGS. 5, 10, and 13, the first wireless terminal (namely 510 of FIG. 5 and STA#1 of FIG. 10) may continue to stay at the first location (namely P1 of FIG. 10) belonging to the existing BSS (namely BSS#1 of FIG. 10).

The second wireless terminal (namely AP#1 of FIG. 10) belonging to the existing BSS (namely BSS#1 of FIG. 10) may change a preconfigured data channel for data transmission. A data channel preconfigured for data transmission may be regarded as any one of a plurality of channels due to channelization of FIGS. 10 and 11.

The first wireless terminal (namely 510 of FIG. 5 and STA#1 of FIG. 10) including the main radio module in the deactivation state (namely OFF state) may receive the WUR target beacon frame (WTBF) based on the WUR module (namely 512 of FIG. 5).

The first wireless terminal (namely 510 of FIG. 5 and STA#1 of FIG. 10) may obtain channel information related to a data channel changed by the second wireless terminal (namely AP#1 of FIG. 10) based on the received WUR target beacon frame (WTBF).

In this case, the first wireless terminal (namely 510 of FIG. 5 and STA#1 of FIG. 10) may instruct the main radio module (511 of FIG. 5) to enter the activation state. Also, the first wireless terminal (namely 510 of FIG. 5 and STA#1 of FIG. 10) may instruct the main radio module (511 of FIG. 5) to hop onto the changed data channel.

Accordingly, the first wireless terminal (namely 510 of FIG. 5 and STA#1 of FIG. 10) may receive a data packet right from the second wireless terminal (namely AP#1 of FIG. 10) through the data channel changed based on the main radio module (511 of FIG. 5) in the activation state.

As an additional embodiment, separate channels may be allocated to the WUR channel for receiving a wake-up packet (WUP) and a data channel for receiving a data packet.

For example, the WUR and data channels may be configured to having a fixed channel within the same channel band (for example, 2.4 GHz). Referring to FIG. 10, the WUR channel may be fixed to the first channel (ch#1) of FIG. 10, and the data channel may be fixed to the sixth channel (ch#6) of FIG. 10.

Also, the WUR and data channels may be configured to have a dynamic channel within the same channel band (for example, 2.4 GHz).

Also, the WUR and data channels may be configured to have different channel bands. For example, the WUR channel may be defined in the 2.4 GHz band of FIG. 10 while the data channel may be defined in the 5 GHz band of FIG. 11. Furthermore, a fixed or dynamic channel may be allocated to each of the WUR and data channels within their defined channel band.

Also, the WUR and data channels may be regarded as a dynamic channel without a limitation on the channel band.

In FIG. 13, control information for associating a STA with an AP is transmitted based on a WUR beacon frame but may be defined by an information element included in the WUR beacon frame (WUR BF) like the channel switch announcement element defined in the existing standard.

It should be noted that specific descriptions of the channel switch announcement element may be found in Clause 9.4.2.19 of the IEEE Draft P802.11-REVmc™/D8.0 disclosed at August 2016.

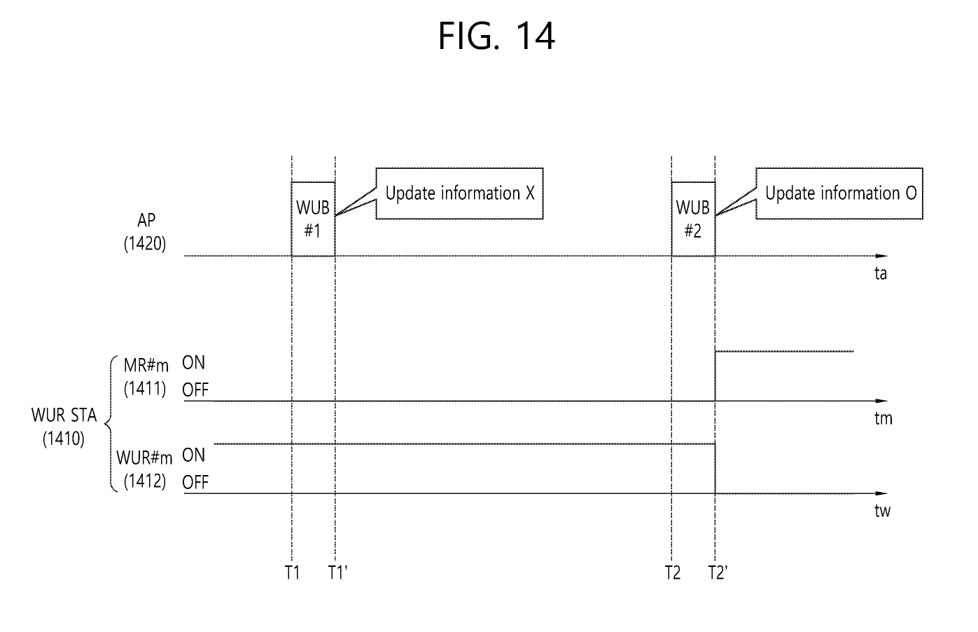

FIG. 14 illustrates a method for managing power performed by a wireless terminal in a wireless LAN system.

Referring to FIGS. 4, 5, 10, 13, and 14, the WUR STA 1410 of FIG. 14 may correspond to the first wireless terminal 410, 510 of FIGS. 4 and 5. Also, the WUR STA 1410 of FIG. 14 may correspond to the first STA (STA#1) or second STA (STA#2) of FIG. 10.

The WUR STA 1410 of FIG. 14 may include a main radio module (MR#m) 1411 and WUR module (WUR#m) 1412. The main radio module (MR#m) 1411 may correspond to the main radio module 411, 511 of FIGS. 4 and 5. The WUR module (WUR#m) 1412 may correspond to the WUR module 412, 512 of FIGS. 4 and 5.

Referring to FIG. 14, the horizontal axis of the main radio module (MR#m) 1411 may represent time (tm). The vertical axis of the main radio module (MR#m) 1411 may represent the power state (ON or OFF state) of the main radio module (MR#m) 1411.

For example, if the vertical axis of the main radio module (MR#m) 1411 is at a high level, the main radio module (MR#m) 1411 may be in the activation state (namely ON state). On the other hand, if the vertical axis of the main radio module (MR#m) 1411 is at a low level, the main radio module (MR#m) 1411 may be in the deactivation state (namely OFF state).

Referring to FIG. 14, the horizontal axis of the WUR module (WUR#m) 1412 may represent time (tw). The vertical axis of the WUR module (WUR#m) 1412 may represent the power state of the WUR module (WUR#m) 1412.

For example, if the vertical axis of the WUR module (WUR#m) 1412 is at a high level, the WUR module (WUR#m) 1412 may be in the turn-on state (namely ON state). On the other hand, if the vertical axis of the WUR module (WUR#m) 1412 is at a low level, the WUR module (WUR#m) 1412 may be in the turn-off state (namely OFF state).

The AP 1420 of FIG. 14 may correspond to the second wireless terminal 420, 520 of FIGS. 4 and 5 and the first AP (AP#1) and second AP (AP#2) of FIG. 10. Referring to FIG. 14, the horizontal axis of AP 1420 may represent time ta, and the vertical axis may be associated with existence of a frame transmitted by the AP 1420.

In the first interval (T1˜T1′) of FIG. 14, the AP 1420 may transmit a first wake-up beacon (hereinafter, ‘WUB’). The WUB described in FIG. 14 may be regarded as the WUR target beacon frame (WTBF) for the WUR module (for example, 412, 512) described with reference to FIG. 13 above.

For example, the AP 1420 may consider synchronization with a WUR STA 1410 in the deep sleep state for a long time period based on a WUB frame.

As one example, the main radio module 1411 of the WUR STA 1410 in the deep sleep state may be in the deactivation state (namely OFF state) while only the WUR module 1412 is in the turn-on state (namely ON state).

Also, based on the WUB frame, the AP 1420 may check whether a connection to the WUR STA 1410 in the deep sleep state is maintained.

The AP 1420 may transmit a WUB frame at a predetermined period (for example, T1˜T2 of FIG. 14). The WUB frame may include information about a BSS search (for example, probe scanning) and information about a connection (for example, BSS color information).

The wake-up packet (WUP) 521 described with reference to FIG. 5 is a frame for making the main radio module of the first wireless terminal enter into the activation state if the second wireless terminal buffers data for the first wireless terminal.

In other words, the WUP 521 may be transmitted in an event-driven manner. In other words, the WUP may be transmitted under an assumption that a connection between the second wireless terminal and the first wireless terminal is maintained.

On the other hand, the WUB frame mentioned in FIG. 14 may be used for a search of an AP (namely BSS). Also, the WUB frame may be used for maintaining a connection to an AP.

In other words, to perform passive scanning for a search of an AP (namely BSS), the WUR STA in the deep sleep state needs to receive a wake-up beacon (WUB) frame transmitted by an AP.

In the first interval (T1˜T1′) of FIG. 14, the WUR STA 1410 may receive a first wake-up beacon (WUB#1) frame based on the WUR module (WUR#m) 1412 in the turn-on state (namely ON state).

The first wake-up beacon (WUB#1) may include first control information. For example, the first control information may include at least one of BSS color information (BCI) related to a BSS to which the AP 1420 belongs, channel information indicating a data channel for communicating with the AP 1420 based on the main radio module, and packet indicator which indicates existence of a data packet for the WUR STA 1410 buffered by the AP 1420.

If the first control information is included in the first wake-up beacon (WUB#1), the WUR STA 1410 may regard the first control information as updated update information.

Furthermore, by comparing preconfigured control information with the first control information included in the first wake-up beacon (WUB#1), the WUR STA 1410 may determine existence of update information.

In the first interval (T1˜T1′) of FIG. 14, it may be determined that update information does not exist in the first wake-up beacon (WUB#1) frame.

In this case, the WUR STA 1410 may instruct the main radio module (MR#m) 1411 to remain in the deactivation state (namely OFF state) during the subsequent interval (T1′ T2). The WUR STA 1410 may instruct the WUR module (WUR#m) 1412 to remain in the turn-on state (namely ON state) during the subsequent interval (T1′˜T2).

In the second interval (T2˜T2′) of FIG. 14, the WUR STA 1410 may transmit a second wake-up beacon (WUB#2) based on the WUR module (WUR#m) 1412 in the turn-on state (namely ON state).

The second wake-up beacon (WUB#2) may include second control information. For example, the second control information may include at least one of BSS color information (BCI) related to a BSS to which the AP 1420 belongs, channel information indicating a data channel for communicating with the AP 1420 based on the main radio module, and packet indicator which indicates existence of a data packet for the WUR STA 1410 buffered by the AP 1420.

If the second control information is included in the second wake-up beacon (WUB#2), the WUR STA 1410 may regard the second control information as updated update information.

Furthermore, by comparing preconfigured control information with the second control information included in the second wake-up beacon (WUB#2), the WUR STA 1410 may determine existence of update information.

In the second interval (T2˜T2′) of FIG. 14, it may be determined that update information exists in the second wake-up beacon (WUB#2) frame.

In this case, the WUR STA 1410 may instruct the main radio module (MR#n) 1411 to enter into the activation state (namely ON state). The WUR STA 1410 may instruct the WUR module (WUR#m) 1412 to enter into the turn-off state (namely OFF state).

The state of the main radio module and the state of the WUR module of a wireless terminal may be associated with each other or independent from each other.

For example, suppose that the main radio module is in the deactivation state, and the WUR module is in the turn-on state. Afterwards, even if the main radio module enters into the activation state, the WUR module main remain in the activation state.

For example, suppose the main radio module is in the deactivation state, and the WUR module is in the turn-on state. Afterwards, if the main radio module enters into the activation state, the WUR module may enter into the turn-off state. Subsequently, the WUR module may remain in the turn-off state until the main radio module enters again into the deactivation state.

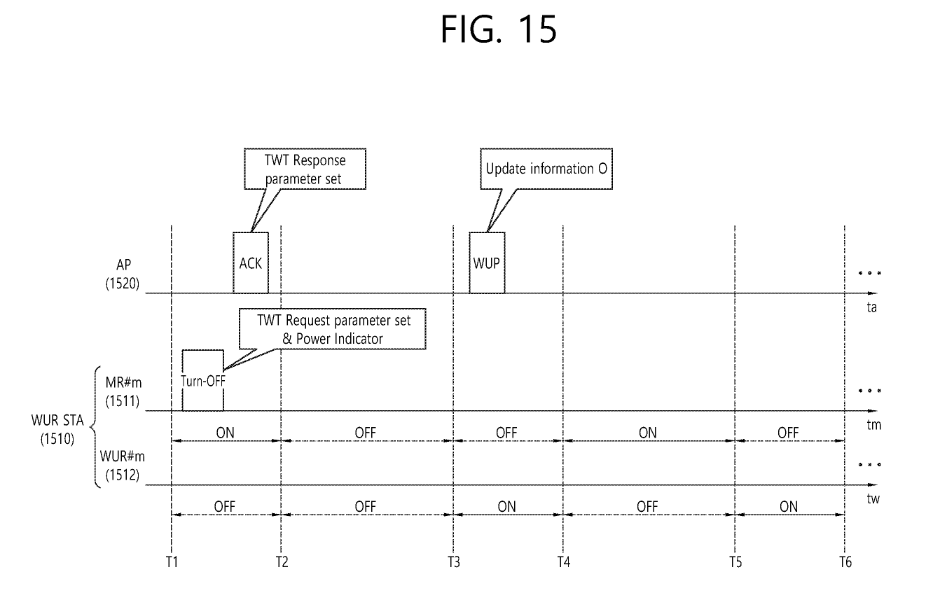

FIG. 15 illustrates a method for managing power in a wireless LAN system according to one embodiment of the present invention.

Referring to FIGS. 14 and 15, the WUR STA 1510 of FIG. 15 may correspond to the WUR STA 1410 of FIG. 14. The main radio module (MR#m) 1511 of FIG. 15 may correspond to the main radio module 1411 of FIG. 14. The WUR module (WUR#m) 1512 of FIG. 15 may correspond to the WUR module 1412 of FIG. 14. The AP 1520 of FIG. 15 may correspond to the AP 1420 of FIG. 14.

The horizontal axis of the main radio module (MR#m) 1511 of FIG. 15 may indicate time (tm). Also, an arrow below the horizontal axis of the main radio module (MR#m) 1511 may indicate the power state (namely ON or OFF state) of the main radio module (MR#m) 1511. The vertical axis of the main radio module (MR#m) 1511 may be associated with existence of a frame transmitted through the main radio module (MR#m) 1511.

The horizontal axis of the WUR module (WUR#m) 1512 of FIG. 15 may indicate time (tw). Also, an arrow below the horizontal axis of the WUR module (WUR#m) 1512 may indicate the power state (namely ON or OFF state) of the WUR module (WUR#m) 1512. The vertical axis of the WUR module (WUR#m) 1512 may be associated with existence of a frame transmitted through the WUR module (WUR#m) 1512.

The horizontal axis of the AP 1520 of FIG. 15 may indicate time (ta). Also, the vertical axis of the AP 1520 may be associated with existence of a frame transmitted by the AP 1520.

In the first interval (T1˜T2) of FIG. 15, the WUR STA 1510 may instruct the main radio module 1511 to remain in the activation state (namely ON state). The WUR STA 1510 may instruct the WUR module 1512 to remain in the turn-off state (namely OFF state).

The WUR STA 1510 may transmit, to the AP 1520, a power indicator which indicates that the main radio module enters into the deactivation state and a turn-off packet which includes a target wake time (TWT) request parameter set used for requesting a TWT operation for the WUR module.

For example, the turn-off packet may be transmitted based on the main radio module 1511. For example, if an acknowledgement (hereinafter, ‘ACK’) packet is received in response to the turn-off packet (namely, after T1˜T2), the turn-off packet may indicate that the main radio module 1511 enters into the deactivation state (namely OFF state).

Next, the AP 1520 may transmit an ACK packet including a TWT response parameter set in response to the TWT request parameter set. In other words, the WUR STA 1510 may obtain information about a TWT service period according to the TWT response parameter set received based on the main radio module 1511.

For example, the TWT response parameter set may include first parameter information which indicates a start time (namely T3 of FIG. 15) of the TWT service period, second parameter information which indicates duration (namely T3˜T4 of FIG. 15) of the TWT service period, and third parameter information (for example, a value of T4 to T5 related to the interval between TWT service periods) for a subsequent TWT service period (namely T5˜T6 of FIG. 15) after the current TWT service period.

In the second interval (T2˜T3) of FIG. 15, the WUR STA 1510 may instruct the WUR module 1512 to remain in the turn-off state (namely OFF state) until the WUR STA 1510 enters into the TWT service period according to the TWT response parameter set. Also, the WUR STA 1510 may instruct the main radio module 1511 to remain in the deactivation state.

For extreme power saving, a wireless terminal according to the present one embodiment may instruct both of the main radio module 1511 and WUR module 1512 to remain in the OFF state (namely deactivation state or turn-off state) in a preconfigured interval.

In the second interval (T2˜T3) of FIG. 15, the WUR STA 1510 may not necessarily have to receive a wake-up beacon (WUB) frame transmitted periodically by the AP 1420 mentioned earlier in FIG. 14. Also, the WUR STA 1510 does not need to receive the wake-up packet (WUP) to be described later.

When entering into the third interval (T3˜T4) of FIG. 15, which is a TWT service period defined according to the TWT response parameter set, the WUR STA 1510 may instruct the WUR module 1512 to enter into the turn-on state (namely ON state). Also, the WUR STA 1510 may instruct the main radio module 1511 to remain in the deactivation state (namely OFF state).

In the third interval (T3˜T4) of FIG. 15, the WUR STA 1510 may receive a wake-up packet (WUP) from the AP 1520 based on the WUR module 1512.

The WUP may include control information. For example, the control information may include at least one of BSS color information (BCI) related to a BSS to which the AP 1520 belongs, channel information indicating a data channel for communicating with the AP 1520 based on the main radio module, and packet indicator which indicates existence of a data packet for the WUR STA 1510 buffered by the AP 1520. The WUP of FIG. 15 may be understood by the descriptions given with reference to FIGS. 5 and 6.

If control information is included in the WUP, the WUR STA 1510 may regard the control information as updated update information. Furthermore, by comparing preconfigured control information with the control information included in the wake-up packet (WUP), the WUR STA 1510 may determine existence of update information.

In the third interval (T3˜T4) of FIG. 15, it may be determined that update information exists in the wake-up packet (WUP).

Although not shown in FIG. 15, the WUR STA 1510 may receive a wake-up beacon (WUB) mentioned in FIG. 14 based on the WUR module 1512 in the third interval (T3˜T4) of FIG. 15.

After the fourth time point (T4) of FIG. 15 at which the TWT service period ends, the WUR STA 1510 may instruct the main radio module 1511 to enter into the activation state (namely ON state). After the fourth time point (T4) of FIG. 15, the WUR STA 1510 may instruct the WUR module 1512 to enter into the turn-off state (namely OFF state).

The WUR STA 1510 may deliver update information included in the WUP to the main radio module 1511 when the main radio module 1511 enters into the activation state (namely ON state).

For example, it may be assumed that the update information includes channel information which indicates a data channel for communicating with the AP 1520 and a packet indicator which indicates existence of a data packet for the WUR STA 1510. In this case, the main radio module 1511 may receive a data packet buffered in the AP 1520 after hopping onto the data channel indicated by the delivered update information.

Although not shown in FIG. 15, if the update information is not included in the wake-up packet (WUP), the WUR STA 1510 may instruct the WUR module 1512 to enter again into the turn-off state (namely OFF state).

Also, although not shown in FIG. 15, the WUR STA 1510 may early terminate the TWT service period (T3˜T4) for the WUR module 1512 depending on the needs.

When the TWT service period (T3˜T4) is early terminated, the WUR STA 1510 may transmit the WUR response frame to the AP 1520 through the main radio module 1511 which has entered into the activation state (namely ON state). For example, the WUR response frame may be a PS-poll frame or QoS null frame.

When a wake-up packet (WUP) is received in the TWT service period for the WUR module (hereinafter, WUR TWT service period), the WUR TWT service period may be early terminated at the time the main radio module enters into the activation state. Also, when the WUR STA attempts to operated based only on the WUR module, the TWT service period may be terminated.

When the WUR STA fails to receive any frame from the AP for a predetermined time period within the WUR TWT service period the corresponding WUR TWT service period may be early terminated.

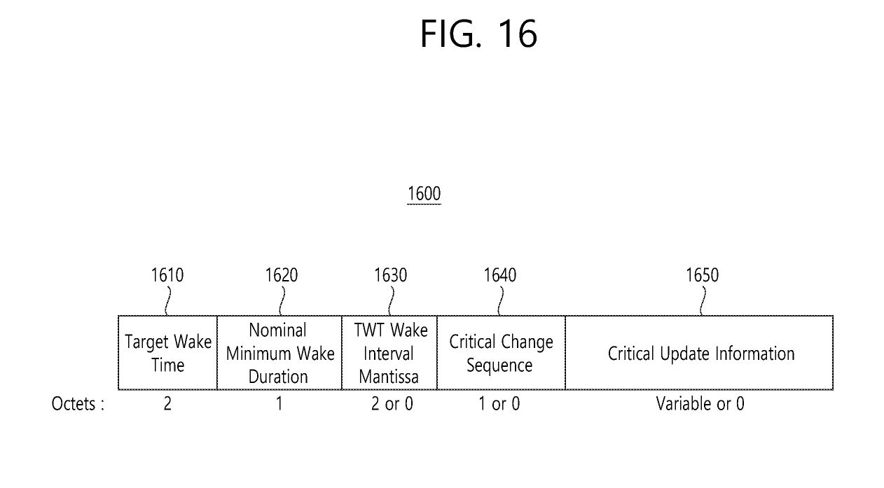

FIG. 16 illustrates a TWT element for a WUR module according to one embodiment of the present invention. Referring to FIG. 16, the TWT element for the WUR module (hereinafter, ‘WUR TWT element’) 1600 may include a plurality of fields 1610, 1620, 1630, 1640, 1650.

Referring to FIGS. 14 to 16, the WUR TWT element 1600 may be included in the wake-up beacon (WUB) frame of FIG. 14. Also, the WUR TWT element 1600 may be included in the turn-off packet, ACK packet, or wake-up packet (WUP) of FIG. 15.

The target wake time (TWT) field 1610 may include information which indicates a start time of the WUR TWT service period. For example, the TWT field 1610 may include information which indicates the start time (for example, T3 of FIG. 15) of the TWT service period of FIG. 15 (for example, T3˜T4 of FIG. 15). For example, 2 octets may be allocated for the TWT field 1610.

The nominal minimum wake duration field 1620 may include information which indicates the duration of the WUR TWT service period (for example, T3˜T4 of FIG. 15). For example, one octet may be allocated for the nominal minimum wake duration field 1620.

The TWT wake interval mantissa field 1630 may include information (for example, T4˜T5 of FIG. 15) for indicating the spacing between the WUR TWT service period and the subsequent WUR TWT service period. For example, 2 octets may be allocated for the TWT wake interval mantissa field 1630.

The critical change sequence field 1640 may indicate whether update information updated by other wireless terminal (for example, AP) has been generated while the WUR module remains in the turn-off state (namely OFF state). For example, one octet may be allocated for the critical change sequence field 1640.

The critical update information field 1650 may correspond to a region which actually includes update information updated by a wireless terminal (for example, AP).

For example, the critical update information field 1650 may include at least one of BSS color information (BCI) related to a BSS to which the AP belongs, channel information indicating a data channel for communicating with the AP based on the main radio module, and packet indicator which indicates existence of a data packet for the WUR STA buffered by the AP. Also, the critical update information field 1650 may include information required for the activation state of the main radio module, such as EDCA parameter for channel contention.

Referring to FIGS. 15 and 16, the turn-off packet and ACK packet transmitted in the first interval (T1˜T2) of FIG. 15 may include only part of the fields 1610, 1620, 1630 of the WUR TWT element 1600. The wake-up packet (WUP) transmitted in the third interval (T3˜T4) of FIG. 15 may include all of the fields 1610 ˜1650 of the WUR TWT element 1600.

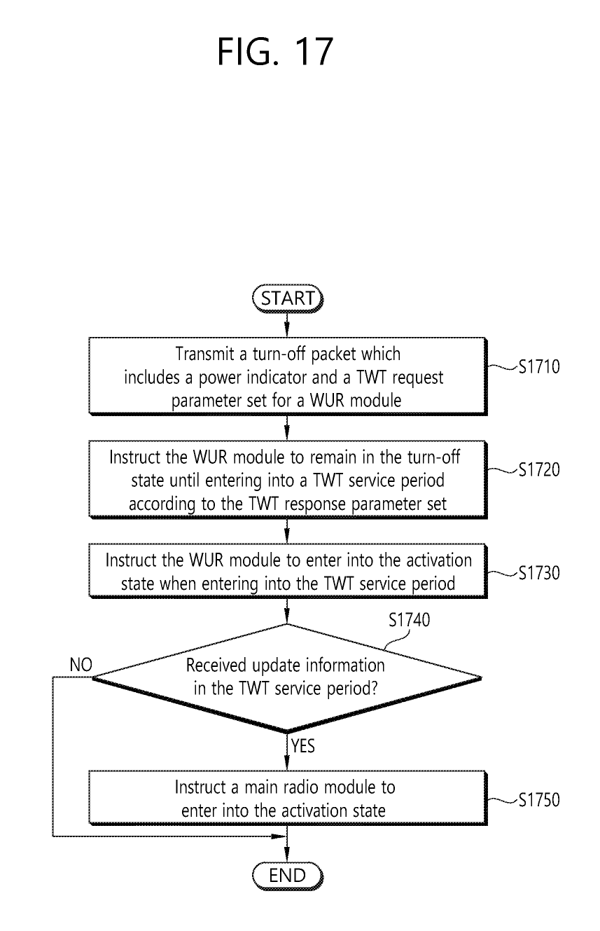

FIG. 17 is a flow diagram illustrating a method for managing power in a wireless LAN system according to one embodiment of the present invention.

In FIG. 17, the first wireless terminal may be regarded as the WUR STA 1510 of FIG. 15. The main radio module included in the first wireless terminal of FIG. 17 may be regarded as the main radio module 1511 of FIG. 15. The WUR module included in the first wireless terminal of FIG. 17 may be regarded as the WUR module 1512 of FIG. 15. Also, the second wireless terminal of FIG. 17 may be regarded as the AP 1520 of FIG. 15.

In the S1710 step, the first wireless terminal may transmit, to the second wireless terminal, a power indicator which indicates that the main radio module enters into the deactivation state and a turn-off packet which includes the TWT request parameter set requesting a target wake time (TWT) operation for the WUR module. For example, the turn-off packet may be transmitted based on the main radio module.

In the S1720 step, if an acknowledgement (ACK) packet including the TWT response parameter set is received from the second wireless terminal in response to the TWT request parameter set, the first wireless terminal may instruct the WUR module to remain in the turn-off state until the first wireless terminal enters into the TWT service period according to the TWT response parameter set.

For example, if an ACK packet is received from the second wireless terminal, the first wireless terminal may instruct the main radio module to enter into the deactivation state.

For example, the TWT response parameter set may include first parameter information which indicates a start time of the TWT service period for the WUR module (namely WUR TWT service period), second parameter information which indicates duration of the TWT service period (namely WUR TWT service period), and third parameter information for the subsequent TWT service period (namely subsequent WUR TWT service period) following the TWT service period (namely WUR TWT service period).

In the S1730 step, when entering into the TWT service period for the WUR module (namely WUR TWT service period), the first wireless terminal may instruct the WUR module to enter into the turn-on state from the turn-off state.

For example, when the first wireless terminal enters into the TWT service period for the WUR module (namely WUR TWT service period), the first wireless terminal may instruct the main radio module to remain in the deactivation state.

In the S1740 step, the first wireless terminal may determine whether update information is received from the second wireless terminal based on the WUR module in the TWT service period for the WUR module (namely WUR TWT service period).

For example, the update information may include at least one of Basic Service Set (BSS) color information (BCI) related to a BSS to which the second wireless terminal belongs, channel information indicating a data channel for communicating with the second wireless terminal based on the main radio module, and packet indicator which indicates existence of a data packet for the first wireless terminal buffered by the second wireless terminal.

For example, the update information may be included in the wake-up packet (WUP) for entering the main radio module to the activation state. Also, the wake-up packet may further include fourth parameter information which indicates existence of the update information in advance and fifth parameter information allocated for the update information.

If update information is not received from the second wireless terminal within the TWT service period (namely WUR TWT service period), the procedure may be terminated. Although not shown in FIG. 17, the first wireless terminal may instruct the main radio module to remain in the deactivation state and instruct the WUR module to enter again into the turn-off state.

If the update information is received from the TWT service period, the procedure enters into the S1750 step.

In the S1750 step, the first wireless terminal may instruct the main radio module to enter into the activation state.

According to the present one embodiment, both of the main radio module and WUR module may be in the OFF state (namely deactivation state or turn-off state) in a particular interval. Therefore, according to the present one embodiment, a wireless terminal which supports extreme power saving may be provided.

It should be noted that for most cases, in the presence of a frame to be transmitted by a WUR Tx (for example, AP), the WUR Tx (for example, AP) may transmit a wake-up packet to a WUR Rx (for example, STA) which includes a WUR module to wake up the main radio module (namely Wi-Fi).

However, a frame to be transmitted by the WUR Rx (for example, STA) may be generated even if there is no triggering from the WUR Tx (for example, AP). In this case, the WUR Rx (for example, STA) may inform the WUR module of a current status of the main radio module (namely Wi-Fi) through the primitive information defined within the terminal.

For example, the WUR Rx (for example, STA) may transmit a frame for reporting the activation state of the main radio module (namely Wi-Fi) to the WUR Tx (for example, AP) through the main radio module (namely Wi-Fi).

For example, the WUR Rx (for example, STA) may transmit a frame (for example, Buffer Status Report frame) for reporting the buffer status of the main radio module (namely Wi-Fi) to the WUR Tx (for example, AP) through the main radio module (namely Wi-Fi) based on contention. Though the transmission, the WUR Rx (for example, STA) may implicitly inform that the main radio module (namely Wi-Fi) is in the activation state.

If it is implicitly informed that the main radio module (namely Wi-Fi) is in the activation state, the WUR Tx (for example, AP) may stop the process related to the wake-up packet (WUP) for waking up the main radio module of the WUR Rx (for example, STA).

For example, the WUR Rx (for example, STA) may transmit a data frame buffered in the main radio module (namely Wi-Fi) to the WUR Tx (for example, AP) through the main radio module (namely Wi-Fi) based on contention.

If the WUR Rx (for example, STA) informs the WUR Tx (for example, AP) only of the activation state of the main radio module (namely Wi-Fi), the WUR Rx (for example, STA) may wait to receive a buffer status report poll (BSRP) frame or trigger frame from the WUR Tx (for example, AP).

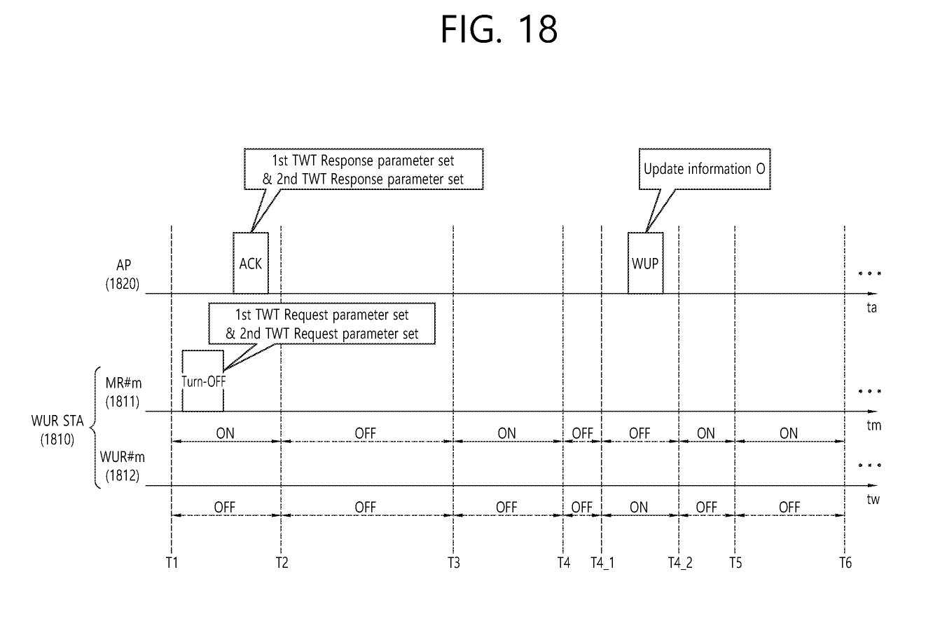

FIG. 18 illustrates a method for managing power in a wireless LAN system according to another embodiment of the present invention.

The main radio module 1811 of FIG. 18 may correspond to the main radio module 1511 of FIG. 15. The WUR module 1812 of FIG. 18 may correspond to the WUR module 1512 of FIG. 15. The AP 1820 of FIG. 18 may correspond to the AP 1520 of FIG. 15.

In the first interval (T1˜T2) of FIG. 18, the WUR STA 1810 may instruct the main radio module 1811 to remain in the activation state (namely ON state). The WUR STA 1810 may instruct the WUR module 1812 to remain in the turn-off state (namely OFF state).

The WUR STA 1810 may transmit, to the AP 1820, a turn-off packet which includes a power indicator indicating that the main radio module 1811 enters into the deactivation state (namely OFF state). In this case, the turn-off packet may be transmitted based on the main radio module 1511.

Also, the turn-off packet may include a first TWT request parameter set requesting a TWT operation for the WUR module 1812 and a second TWT request parameter set requesting a TWT operation for the main radio module 1811.

Next, the AP 1820 may transmit an ACK packet which includes a first TWT response parameter set and a second TWT response parameter set in response to the first TWT request parameter set and the second TWT request parameter set.

For example, the first TWT response parameter set may include first parameter information which indicates a start time (namely T4_1 of FIG. 18) of the WUR TWT service period for the WUR module 1812, second parameter information which indicates duration (namely T4_1˜T4_2 of FIG. 18) of the WUR TWT service period, and third parameter information for a WUR TWT service period (not shown) subsequent to the WUR TWT service period.

For example, the second TWT response parameter set may include fourth parameter information which indicates a start time (namely T3 of FIG. 18) of the TWT service period for the main radio module 1811, fifth parameter information which indicates duration (namely T3˜T4 of FIG. 18) of the TWT service period, and sixth parameter information for a TWT service period (namely T5˜T6 of FIG. 18) subsequent to the TWT service period.

The fourth to sixth parameter information included in the second TWT response parameter set is described in more detail through Clause 9.4.2.200 of the standard document IEEE P802.11ax/D1.3 disclosed at June 2017.

In other words, the WUR STA 1810 may obtain information about the TWT service period (namely T3˜T4 and T5˜T6 of FIG. 18) for the main radio module 1811 and the WUR TWT service period (namely T4_1˜T4_2 of FIG. 18) for the WUR module 1812 in advance according to the first TWT response parameter set and second TWT response parameter set.

In the second interval (T2˜T3) of FIG. 18, the WUR STA 1810 may instruct the main radio module 1811 to remain in the deactivation state (namely OFF state). Also, the WUR STA 1810 may instruct the WUR module 1812 to remain in the turn-off state (namely OFF state).

When the WUR STA 1810 enters into the third interval (T3˜T4) of FIG. 18, which is a TWT service period for the main radio module 1811, the WUR STA 1810 may instruct the main radio module 1811 to enter into the activation state (namely ON state). When the WUR STA 1810 enters into the third interval (T3˜T4) of FIG. 18, the WUR STA 1810 may instruct the WUR module 1812 to remain in the turn-off state (namely OFF state).

In the third interval (T3˜T4) of FIG. 18, even if the wake-up packet (WUP) is not received, the WUR STA 1811 may instruct the main radio module 1811 to enter into the activation state (namely ON state) according to the second TWT response parameter set.

If only the second TWT response parameter set is considered, the WUR STA 1810 may instruct the main radio module 1811 to remain in the deactivation state (namely OFF state) in the fourth interval (T4˜T5).

However, according to the embodiment of FIG. 18, the first TWT response parameter set for the WUR module 1812 may have to be considered together. In other words, the WUR STA 1810 may instruct the WUR module 1812 to remain in the turn-on state (namely ON state) during the WUR TWT service period (namely T4_1˜T4_2) according to the first TWT response parameter set.

Within the WUR TWT service period (namely T4-1˜T4_2), a wake-up packet (WUP) including update information may be received from the AP 1820. Accordingly, at the time the WUR TWT service period (namely T4_1˜T4_2) ends (T4_2), the WUR STA 1810 may instruct the main radio module 1811 to enter into the activation state (namely ON state).

Also, at the time the WUR TWT service period (namely T4_1˜T4_2) ends (T4-2), the WUR STA 1810 may instruct the WUR module 1812 to enter into the turn-off state (namely OFF state).

Next, until the subsequent TWT service period (T5˜T6) for the main radio module 1811 is started (namely T4-2˜T50, the WUR STA 1810 may instruct the main radio module 1811 to remain in the activation state (namely ON state). Also, until the subsequent TWT service period (T5˜T6) is started (namely T4_2˜T5), the WUR STA 1510 may instruct the WUR module 1812 to remain in the turn-off state (namely OFF state).

When the WUR STA 1810 enters into the fifth interval (T5˜T6) of FIG. 18, which is a subsequent TWT service period for the main radio module 1811, the WUR STA 1810 may instruct the main radio module 1811 to enter into the activation state (namely ON state( ) according to the second TWT response parameter set even if a WUP is not received. Also, the WUR STA 1810 may instruct the WUR module 1812 to remain in the turn-off state (namely OFF state).

According to another embodiment of the present invention described in FIG. 18, the TWT operation for the main radio module and the WUR TWT operation for the WUR module may be performed simultaneously.

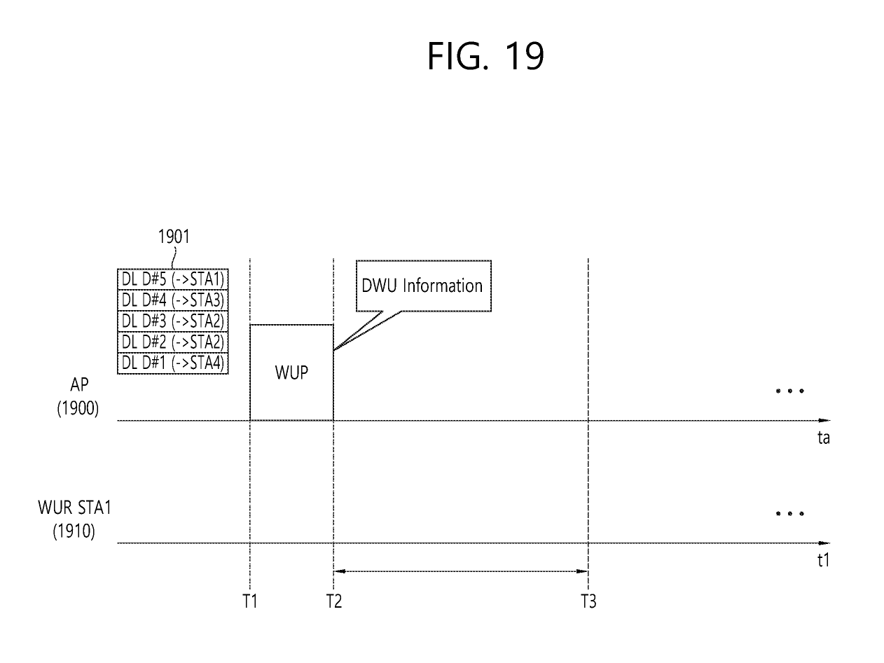

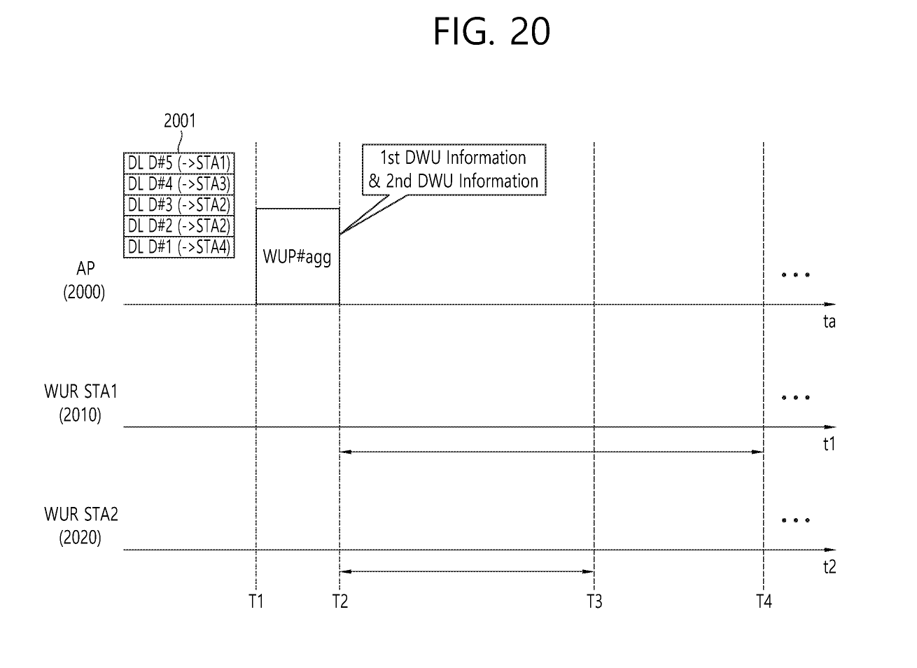

FIGS. 19 and 20 illustrate a method for managing power in a wireless LAN according to yet another embodiment of the present invention.

Referring to FIG. 19, the horizontal axis of AP 1900 represents time (ta), and the vertical axis may be associated with existence of a frame transmitted by the AP 1900.

The AP 1900 may include an AP queue 1901 which buffers data packets to be transmitted to a plurality of user terminals through a downlink. The plurality of user terminals mentioned in FIG. 19 may be regarded as WUR STAs which include a main radio module and WUR module.

The horizontal axis of the first WUR STA 1910 may represent time (t1), and the vertical axis may be associated with existence of a frame to be transmitted by the first WUR STA 1910. The first WUR STA 1910 may be a wireless terminal which include a main radio module and WUR module.

For example, the AP queue 1901 may buffer the first to fifth data packet (DL#1 DL#5) sequentially.

As one example, the first data packet (DL#1) may be addressed to the fourth WUR STA (not shown). The second (DL#2) and third data packet (DL#3) may be addressed to the second WUR STA (not shown).

As one example, the fourth data packet (DL#4) may be addressed to the third WUR STA (not shown). The fifth data packet (DL#5) may be addressed to the first WUR STA 1910.

In the first interval (T1˜T2) of FIG. 19, to wake up the main radio module of the first WUR STA 1910 before transmitting the fifth data packet (DL#5) addressed to the first WUR STA 1910, the AP 1900 may transmit a wake-up packet (WUP).

However, according to yet another embodiment of the present invention, a delay may be occurred, which prevents the fifth data packet (DL#5) from being transmitted immediately due to other data packets (DL#1 DL#4) buffered in the AP queue 1901.

The AP 1900 may include information about a delayed wake up (hereinafter, ‘DWU’) which reflects the delay into the wake-up packet (WUP). For example, DWU information may related to the time duration of the second interval (T2˜T3).

Accordingly, the first WUR STA 1910 may instruct the main radio module to enter into the activation state after the third time point (T3) of FIG. 19. Subsequently, the WUR STA 1910 may receive the fifth data packet (DL#5) from the AP 1900 based on the main radio module which has entered into the activation state.

Referring to FIG. 20, the AP 2000 of FIG. 20 may correspond to the AP 1900 of FIG. 19. The AP queue 2001 of FIG. 20 may correspond to the AP queue 1901 of FIG. 19.

The first WUR STA 2010 and second WUR STA 2020 of FIG. 20 may be a wireless terminal which includes a main radio module and WUR module.

The horizontal axis of the first WUR STA 2010 represents time (t1), and the vertical axis may be associated with existence of a frame transmitted by the first WUR STA 2010. The horizontal axis of the second WUR STA 2020 represents time (t2), and the vertical axis may be associated with existence of a frame transmitted by the second WUR STA 2020.

In the first interval (T1˜T2) of FIG. 20, the AP 2000 may transmit an aggregated wake-up packet (WUP#agg).

For example, it may be assumed that among a plurality of WUR STAs addressed by a plurality of data packets buffered in the AP queue 2001, only the first WUR STA 2010 and second WUR STA 2020 are in the deep sleep state.

In other words, in the first interval (T1˜T2), the first WUR STA 2010 may instruct the WUR module to remain in the turn-on state and instruct the main radio module to remain in the deactivation state. The second WUR STA 2020 may instruct the WUR module to remain in the turn-on state and instruct the main radio module to remain in the deactivation state.

The AP 2000 may include a plurality of delayed wake-up (DWU) information reflecting a plurality of delays in the aggregated wake-up packet (WUP#agg).

For example, the first DWU information may correspond to the time duration spanning from the second to the fourth time point (T2˜T4).

Accordingly, the first WUR STA 2010 may instruct the main radio module to enter into the activation state after the fourth time point (T4) of FIG. 20. Next, the first WUR STA 2010 may receive the fifth data packet (DL#5) from the AP 2000 based on the main radio module which has entered into the activation state.

For example, the second DWU information may correspond to the time duration spanning from the second to the third time point (T2˜T3).

Accordingly, the second WUR STA 2020 may instruct the main radio module to enter into the activation state after the third time point (T3) of FIG. 20. Next, the second WUR STA 2020 may receive the second (DL#2) and third data packet (DL#3) from the AP 2000 based on the main radio module which has entered into the activation state.

According to still another embodiment of the present invention of FIGS. 19 and 20, each WUR STA may instruct the main radio module to enter into the activation state at a different time point according to the information included in a wake-up packet.

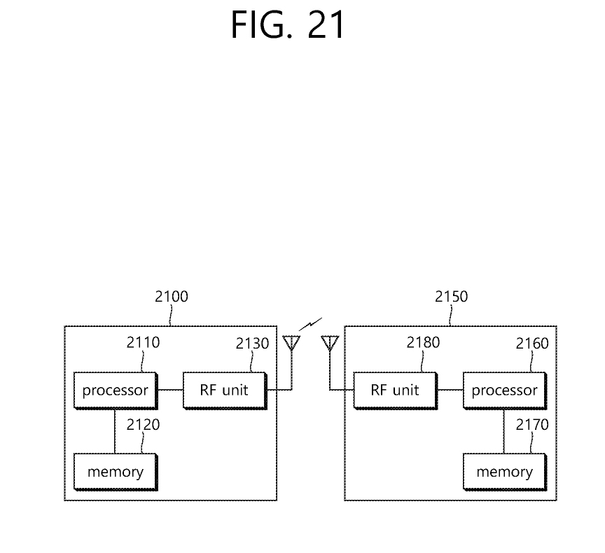

FIG. 21 is a block view illustrating a wireless device to which the exemplary embodiment of the present invention can be applied.

Referring to FIG. 21, as an STA that can implement the above-described exemplary embodiment, the wireless device may correspond to an AP or a non-AP station (STA). The wireless device may correspond to the above-described user or may correspond to a transmitting device transmitting a signal to the user.

The AP 2100 includes a processor 2110, a memory 2121, and a radio frequency (RF) unit 2130.

The RF unit 2130 is connected to the processor 2110, thereby being capable of transmitting and/or receiving radio signals.

The processor 2110 implements the functions, processes, and/or methods proposed in the present invention. For example, the processor 2110 may be implemented to perform the operations according to the above-described exemplary embodiments of the present invention. More specifically, among the operations that are disclosed in the exemplary embodiments of FIG. 1 to FIG. 19, the processor 2110 may perform the operations that may be performed by the AP.

The non-AP STA 2150 includes a processor 2160, a memory 2170, and a radio frequency (RF) unit 2180.

The RF unit 2180 is connected to the processor 2160, thereby being capable of transmitting and/or receiving radio signals.

The processor 2160 implements the functions, processes, and/or methods proposed in the present invention. For example, the processor 2160 may be implemented to perform the operations of the non-AP STA according to the above-described exemplary embodiments of the present invention. The processor may perform the operations of the non-AP STA, which are disclosed in the exemplary embodiments of FIG. 1 to FIG. 20.

The processor 2110 and 2160 may include an application-specific integrated circuit (ASIC), another chip set, a logical circuit, a data processing device, and/or a converter converting a baseband signal and a radio signal to and from one another. The memory 2121 and 2170 may include a read-only memory (ROM), a random access memory (RAM), a flash memory, a memory card, a storage medium, and/or another storage device. The RF unit 2130 and 2180 may include one or more antennas transmitting and/or receiving radio signals.

When the exemplary embodiment is implemented as software, the above-described method may be implemented as a module (process, function, and so on) performing the above-described functions. The module may be stored in the memory 2121 and 2170 and may be executed by the processor 2110 and 2160. The memory 2121 and 2170 may be located inside or outside of the processor 2110 and 2160 and may be connected to the processor 2110 and 2160 through a diversity of well-known means.

Although an embodiment of the invention has been described in detail in the present specification, various modifications are possible without departing from the scope of the present specification. Therefore, the scope of the present specification should not be construed as being limited to the aforementioned embodiment, but should be defined by not only claims of the invention described below but also equivalents to the claims.

What is claimed is:

1. A method for managing power performed by a first wireless terminal including a main radio module and WUR module in a wireless LAN system, the method comprising:
transmitting to a second wireless terminal a turn-off packet including a power indicator that instructs that the main radio module enters into a deactivation state and a TWT request parameter set that requests a target wake time (TWT) operation for the WUR module;
when an acknowledgement packet including a TWT response parameter set is received from the second wireless terminal in response to the TWT request parameter set, instructing the WUR module to maintain a turn-off state until entering a TWT service period based on the TWT response parameter set;
instructing the WUR module to enter into a turn-on state from the turn-off state when entering the TWT service period;
determining whether or not update information is received from the second wireless terminal based on the WUR module in the TWT service period; and
when the update information is received in the TWT service period, instructing the main radio module to enter into an activation state.

2. The method of claim 1, wherein the update information includes at least one of basic service set (BSS) color information related to a BSS to which the second wireless terminal belongs, channel information related to a data channel for communicating with the second wireless terminal based on the main radio module, and packet indicator related to existence of a data packet for the first wireless terminal buffered by the second wireless terminal.

3. The method of claim 1, wherein the turn-off packet is transmitted based on the main radio module, and further comprising:
If the acknowledgement packet is received form the second wireless terminal, instructing the main radio module to enter into the deactivation state.

4. The method of claim 1, wherein the TWT response parameter set includes first parameter information related to a start time of the TWT service period, second parameter information related to duration of the TWT service period, and third parameter information for a subsequent TWT service period after the TWT service period.

5. The method of claim 1, further comprising:
instructing the main radio module to maintain the deactivation state when entering into the TWT service period;
if the update information is not received in the TWT service period, instructing the main radio module to maintain the deactivation state; and
if the update information is not received in the TWT service period, instructing the WUR module to enter again into the turn-off state.

6. The method of claim 1, wherein the update information is included in a wake-up packet for making the main radio module enter into the activation state.

7. The method of claim 6, wherein the wake-up packet further includes fourth parameter information related to existence of the update information in advance and fifth parameter information allocated for the update information.

8. The method of claim 6, wherein the wake-up packet includes a payload modulated based on On-Off Keying (OOK) scheme for the WUR module, and
wherein the payload is implemented based on an ON signal determined by a 1-bit ON signal by the WUR module and an OFF signal determined by a 1-bit OFF signal by the WUR module.

9. The method of claim 8, wherein the ON signal is obtained by performing Inverse Fast Fourier Transform (IFFT) on N2 subcarriers among N1 subcarriers related to a channel band of the wake-up packet,
wherein a preconfigured sequence is applied to the N2 subcarriers, and
wherein the N1 and N2 are natural numbers.

10. A first wireless terminal comprising a main radio module and a wake-up receiver (WUR) module for a method for managing power in a wireless LAN system, the first wireless terminal comprising:
a transceiver transmitting and receiving a radio signal; and
a processor connected to the transceiver, wherein the processor is configured to:
transmit to a second wireless terminal a turn-off packet including a power indicator that instructs that the main radio module enters into a deactivation state and a TWT request parameter set that requests a target wake time (TWT) operation for the WUR module;
if an acknowledgement packet including a TWT response parameter set is received from the second wireless terminal in response to the TWT request parameter set, instruct the WUR module to maintain a turn-off state until entering a TWT service period based on the TWT response parameter set;
instruct the WUR module to enter into a turn-on state from the turn-off state when entering the TWT service period;
determine whether or not update information is received from the second wireless terminal based on the WUR module in the TWT service period; and
when the update information is received in the TWT service period, instruct the main radio module to enter into an activation state.
